(19) United States
(12) Patent Application Publication
(10) Pub. No.: US 2026/0013495 A1
(43) Pub. Date: Jan. 15, 2026

(54) PRECISION APPLICATION DEVICES AND COMPOSITIONS

(71) Applicant: SYNGENTA CROP PROTECTION AG, Basel (CH)

(72) Inventors: Simon James CALDWELL, Berkshire (GB); Nicholas Jonathan William PENFOLD, Berkshire (GB); Apostolos SEVASTOS, Berkshire (GB); Philip TAYLOR, Berkshire (GB)

(73) Assignee: SYNGENTA CROP PROTECTION AG, Basel (CH)

(21) Appl. No.: 18/881,938

(22) PCT Filed: Jun. 30, 2023
(86) PCT No.: PCT/EP2023/067955

§ 371 Date: Jan. 7, 2025

(30) Foreign Application Priority Data
Jul. 7, 2022 (GR) 20220100542
Nov. 3, 2022 (GB) 2216335.6

(51) Int. Cl. A01N 25/04; A01M 7/00; A01P 13/00

(52) U.S. Cl. CPC A01N 25/04; A01P 13/00; A01M 7/0025

(57) ABSTRACT

A composition comprising: an agrochemical; diutan gum; and a carrier fluid, wherein the diutan gum is present in an amount of from 0.001 to 2% by weight, wherein the carrier fluid comprises water and is present in an amount of from 65 to 95% by weight.

The present invention relates to an agrochemical composition, precision application devices containing such a composition and uses of the same.

Agrochemicals are biologically active materials such as herbicides, fungicides and insecticides used by farmers and growers to control weeds and insect and fungal pests in, on, or around their crops. Typically, agrochemicals are supplied as a concentrate which is diluted with water before application to form the final composition to be applied. Typically, the diluted composition of agrochemical is applied by spray application. Spray application allows large areas to be covered relatively quickly. The spray can be applied by hand, by specialist tractor-mounted spray equipment or even by aircraft depending on the scale of the application. Conventional agrochemical spraying generally relies on producing a fan or cone of fine spray droplets from nozzles using a pressurised supply of dilute agrochemical formulation. This allows the application of dilute agrochemical evenly over relatively large areas with sweeps of the sprayer.

In recent times it has been recognised that for some applications it could be advantageous to use a more targeted application of agrochemical, rather than evenly covering an entire area such as a field. For example, if individual weeds can be identified by an automated recognition system connected to an automated application system, then it should be possible for the system to apply herbicide just to those weeds. Similarly, if individual plants can be identified that are infested with insects or fungi then it should be possible to treat just those infested plants with an insecticide or fungicide. Alternatively, for crops that grow in regular rows a herbicide could be applied only in the space between the rows. For herbicides, this would allow the use of a non-selective herbicide (one which kills virtually all plants) to target the weeds amongst a growing crop plant. For all types of agrochemical, it could also allow the use of a much lower average level of agrochemical across the field as a whole, lowering costs for the farmer and lowering the amount of agrochemical in the environment. This targeted spray application is known as ‘precision application’.

‘Precision application’ is defined as the application of agrochemicals to discrete parts of the target location rather than the entire area (broadcast application). Types of precision application include, but are not limited to, hooded/banded application, variable rate application using prescription maps and optical spot spraying. Precision application also includes this type of targeted application in non-row crop type applications, such as in-furrow application or orchard spraying. For all types of precision application, the application device will likely require a specialist nozzle for more precisely directing the agrochemical product, typically these would be, but are not limited to, smaller angle hydraulic nozzles or jetting type nozzles. The most sophisticated of the precision application types is optical spot spraying which will include, on top of or in lieu of standard application equipment, an imaging system and an analysis system for deciding the application location.

Precision application requires a different type of spray pattern from the conventional one. By its nature, the precision spray is intended not to spread and cover a large area, but instead it must ideally land exactly where it is targeted and nowhere else. This calls for a spray pattern which is a small jet of liquid or narrow angle fan of fine droplets rather than traditional wide-angle fans or cones.

It has been found that applying a highly precise dose of liquid agrochemical in water rather than a broad spray introduces a problem. The problem is that a significant proportion of the spray tends to bounce or shatter off the target as small droplets and land some distance from the target. This introduces a spread of the agrochemical so that instead of all landing exactly where it is intended, it additionally lands on neighbouring plants and soil. This undermines the whole concept of precision application. If a non-selective herbicide is being used to target weeds, then neighbouring crop plants may be damaged or killed. For any agrochemical it requires additional pesticide to be applied to make up for the material being wasted by ending up where it is not needed.

The problem is made worse because most agrochemical compositions contain surfactants and emulsifiers. Some of these are included to improve the physical or chemical stability of the agrochemical concentrate or to improve and maintain the dispersion of the dilute agrochemical the spray tank. Others are included to increase the biological effect of the agrochemical by improving the ability of the dilute composition to spread across the surface of a target plant or to penetrate the outer surface of a target plant, insect or fungus. Because of their surfactant properties, such materials increase the formation of small droplets when the liquid lands on a surface and so makes the problem of off target movement worse. It is therefore highly desirable to reduce off target movement and we herein refer to this as reducing the shatter of the composition.

‘Droplet shatter’ is defined as the break-up of a primary liquid droplet(s) of nominal diameter upon impact with a surface, that subsequently results in a higher number of smaller, secondary droplets which fall outside the area of initial impact. ‘Shatter reduction’ is accordingly defined as percentage reduction in total number of secondary droplets due to a change in the composition or in comparison to a reference composition. Thus, there is a need for low shatter compositions that are suitable for precision application uses and devices.

In a first aspect of the invention there is therefore provided a composition comprising: an agrochemical;
diutan gum; and
a carrier fluid wherein the diutan gum is present in an amount of from 0.001 to 2% by weight,
wherein the carrier fluid comprises water and is present in an amount of from 65 to 95% by weight.

It has surprisingly been found that compositions according to the invention address the technical challenges set out above.

Advantageously the carrier fluid is present in an amount of from 68 to 93% by weight, such as from 69 to 92% by weight, from 70 to 91% by weight, or from 71 to 90% by weight.

Preferably the carrier fluid comprises water in an amount from 80 to 100% or from 80 to 99.5% by weight of the carrier fluid.

The diutan gum may be present in an amount of from 0.01 to 0.20% by weight.

Advantageously the agrochemical is used at the maximum usage rate per the label of the active ingredient.

The agrochemical may be used in an amount of from 0.0001 to 25% by weight, such from 0.001 to 20% by weight, from 0.01 to 5% by weight, or from 6 to 15% by weight.

One or more agrochemicals, or a salt of the agrochemical(s), selected from those given below is/are suitable for the present invention.

Suitable herbicides or plant growth regulators may be selected from acetochlor, acifluorfen (including acifluorfen-sodium), aclonifen, ametryn, amicarbazone, aminopyralid, aminotriazole, atrazine, beflubutamid-M, benquitrione, bensulfuron (including bensulfuron-methyl), bentazone, bicyclopyrone, bilanafos, bipyrazone, bispyribac-sodium, bixlozone, bromacil, bromoxynil, butachlor, butafenacil, carfentrazone (including carfentrazone-ethyl), cloransulam (including cloransulam-methyl), chlorimuron (including chlorimuron-ethyl), chlorotoluron, chlorsulfuron, cinmethylin, clacyfos, clethodim, clodinafop (including clodinafop-propargyl), clomazone, clopyralid, cyclopyranil, cyclopyrimorate, cyclosulfamuron, cyhalofop (including cyhalofop-butyl), 2,4-D (including the choline salt and 2-ethylhexyl ester thereof), 2,4-DB, desmedipham, dicamba (including the aluminium, aminopropyl, bis-aminopropylmethyl, choline, dichloroprop, diglycolamine, dimethylamine, dimethylammonium, potassium and sodium salts thereof) diclosulam, diflufenican, diflufenzopyr, dimethachlor, dimethenamid-P, dioxopyritrione, diquat dibromide, diuron, epyrifenacil, ethalfluralin, ethofumesate, fenoxaprop (including fenoxaprop-P-ethyl), fenoxasulfone, fenpyrazone, fenquinotrione, fentrazamide, flazasulfuron, florasulam, florpyrauxifen (including florpyrauxifen-benzyl), fluazifop (including fluazifop-P-butyl), flucarbazone (including flucarbazone-sodium), flufenacet, flumetsulam, flumioxazin, fluometuron, fomesafen flupyrsulfuron (including flupyrsulfuron-methyl-sodium), fluroxypyr (including fluroxypyr-meptyl), fomesafen, foramsulfuron, glufosinate (including L-glufosinate and the ammonium salts of both), glyphosate (including the diammonium, isopropylammonium and potassium salts thereof), halauxifen (including halauxifen-methyl), haloxyfop (including haloxyfop-methyl), hexazinone, hydantocidin, imazamox (including R-imazamox), imazapic, imazapyr, imazethapyr, indaziflam, iodosulfuron (including iodosulfuron-methyl-sodium), iofensulfuron (including iofensulfuron-sodium), ioxynil, isoproturon, isoxaflutole, lancotrione, MCPA, MCPB, mecoprop-P, mesosulfuron (including mesosulfuron-methyl), mesotrione, metamitron, metazachlor, methiozolin, metolachlor, metosulam, metribuzin, metsulfuron, napropamide, nicosulfuron, norflurazon, oxadiazon, oxasulfuron, oxyfluorfen, paraquat dichloride, pendimethalin, penoxsulam, phenmedipham, picloram, pinoxaden, pretilachlor, primisulfuron-methyl, prometryne, propanil, propaquizafop, propyrisulfuron, propyzamide, prosulfocarb, prosulfuron, pyraclonil, pyraflufen (including pyraflufen-ethyl), pyrasulfotole, pyridate, pyriftalid, pyrimisulfan, pyroxasulfone, pyroxsulam, quinclorac, quinmerac, quizalofop (including quizalofop-P-ethyl and quizalofop-P-tefuryl), rimisoxafen, rimsulfuron, saflufenacil, sethoxydim, simazine, S-metalochlor, sulfentrazone, sulfosulfuron, tebuthiuron, tefuryltrione, tembotrione, terbuthylazine, terbutryn, tetflupyrolimet, thiencarbazone, thifensulfuron, tiafenacil, tolpyralate, topramezone, tralkoxydim, triafamone, triallate, triasulfuron, tribenuron (including tribenuron-methyl), triclopyr, trifloxysulfuron (including trifloxysulfuron-sodium), trifludimoxazin, trifluralin, triflusulfuron, tripyrasulfone, [(E)-[2-(trifluoromethyl)phenyl]methyleneamino]2,6-bis[(4,6-dimethoxypyrimidin-2-yl)oxy]benzoate, 3-(2-chloro-4-fluoro-5-(3-methyl-2,6-dioxo-4-trifluoromethyl-3,6-dihydropyrimidin-1(2H)-yl)phenyl)-5-methyl-4,5-dihydroisoxazole-5-carboxylic acid ethyl ester, 4-hydroxy-1-methoxy-5-methyl-3-[4-(trifluoromethyl)-2-pyridyl]imidazolidin-2-one, 4-hydroxy-1,5-dimethyl-3-[4-(trifluoromethyl)-2-pyridyl]imidazolidin-2-one, 5-ethoxy-4-hydroxy-1-methyl-3-[4-(trifluoromethyl)-2-pyridyl]imidazolidin-2-one, 4-hydroxy-1-methyl-3-[4-(trifluoromethyl)-2-pyridyl]imidazolidin-2-one, 4-hydroxy-1,5-dimethyl-3-[1-methyl-5-(trifluoromethyl)pyrazol-3-yl]imidazolidin-2-one, (4R)1-(5-tert-butylisoxazol-3-yl)-4-ethoxy-5-hydroxy-3-methyl-imidazolidin-2-one, 4-amino-3-chloro-5-fluoro-6-(7-fluoro-1H-indol-6-yl)pyridine-2-carboxylic acid (including agrochemically acceptable esters thereof, for example, methyl 4-amino-3-chloro-5-fluoro-6-(7-fluoro-1H-indol-6-yl)pyridine-2-carboxylate, prop-2-ynyl 4-amino-3-chloro-5-fluoro-6-(7-fluoro-1H-indol-6-yl)pyridine-2-carboxylate and cyanomethyl 4-amino-3-chloro-5-fluoro-6-(7-fluoro-1H-indol-6-yl)pyridine-2-carboxylate), 3-ethylsulfanyl-N-(1,3,4-oxadiazol-2-yl)-5-(trifluoromethyl)-[1,2,4]triazolo[4,3-a]pyridine-8-carboxamide, 3-(isopropylsulfanylmethyl)-N-(5-methyl-1,3,4-oxadiazol-2-yl)-5-(trifluoromethyl)-[1,2,4]triazolo[4,3-a]pyridine-8-carboxamide, 3-(isopropylsulfonylmethyl)-N-(5-methyl-1,3,4-oxadiazol-2-yl)-5-(trifluoromethyl)-[1,2,4]triazolo[4,3-a]pyridine-8-carboxamide, 3-(ethylsulfonylmethyl)-N-(5-methyl-1,3,4-oxadiazol-2-yl)-5-(trifluoromethyl)-[1,2,4]triazolo[4,3-a]pyridine-8-carboxamide, ethyl-2-[[3-[[3-chloro-5-fluoro-6-[3-methyl-2,6-dioxo-4-(trifluoromethyl)pyrimidin-1-yl]-2-pyridyl]oxy]acetate,6-chloro-4-(2,7-dimethyl-1-naphthyl)-5-hydroxy-2-methyl-pyridazin-3-one, tetrahydrofuran-2-ylmethyl (2R)-2-[(4-amino-3,5-dichloro-6-fluoro-2-pyridyl)oxy]propanoate, (2R)-2-[(4-amino-3,5-dichloro-6-fluoro-2-pyridyl)oxy]propanoic acid, tetrahydrofuran-2-ylmethyl 2-[(4-amino-3,5-dichloro-6-fluoro-2-pyridyl)oxy]propanoate, 2-[(4-amino-3,5-dichloro-6-fluoro-2-pyridyl)oxy]propanoic acid, 2-fluoro-N-(5-methyl-1,3,4-oxadiazol-2-yl)-3-[(R)-propylsulfinyl]-4-(trifluoromethyl)benzamide, 2-fluoro-N-(5-methyl-1,3,4-oxadiazol-2-yl)-3-propylsulfinyl-4-(trifluoromethyl)benzamide, (2-fluorophenyl)methyl 6-amino-5-chloro-2-(4-chloro-2-fluoro-3-methoxy-phenyl)pyrimidine-4-carboxylate, 6-amino-5-chloro-2-(4-chloro-2-fluoro-3-methoxy-phenyl)pyrimidine-4-carboxylic acid, 3-(3-chlorophenyl)-6-(5-hydroxy-1,3-dimethyl-pyrazole-4-carbonyl)-1,5-dimethyl-quinazoline-2,4-dione and [4-[3-(3-chlorophenyl)-1,5-dimethyl-2,4-dioxo-quinazoline-6-carbonyl]-2,5-dimethyl-pyrazol-3-yl]N,N-diethylcarbamate, methyl 2-[(E)-[2-chloro-4-fluoro-5-[3-methyl-2,6-dioxo-4-(trifluoromethyl)pyrimidin-1-yl]phenyl]methyleneamino]oxypropanoate and methyl (2R)-2-[(E)-[2-chloro-4-fluoro-5-[3-methyl-2,6-dioxo-4-(trifluoromethyl)pyrimidin-1-yl]phenyl]methyleneamino]oxypropanoate.

The above compounds or mixtures can also be used in combination with one or more herbicide safeners. Examples of such safeners include benoxacor, cloquintocet (including cloquintocet-mexyl), cyprosulfamide, dichlormid, fenchlorazole (including fenchlorazole-ethyl), fenclorim, fluxofenim, furilazole, isoxadifen (including isoxadifen-ethyl), mefenpyr (including mefenpyr-diethyl), metcamifen and oxabetrinil.

Suitable insecticides may be selected from abamectin, acequinocyl, acetamiprid, acetoprole, acrinathrin, acynonapyr, afidopyropen, afoxolaner, alanycarb, allethrin, alpha-cypermethrin, alphamethrin, amidoflumet, aminocarb, azocyclotin, bensultap, benzoximate, benzpyrimoxan, betacyfluthrin, beta-cypermethrin, bifenazate, bifenthrin, binapacryl, bioallethrin, S-bioallethrin, bioresmethrin, bistrifluron, broflanilide, brofluthrinate, bromophos-ethyl, buprofezine, butocarboxim, cadusafos, carbaryl, carbosulfan, cartap, CAS number: 1632218-00-8, CAS number: 1808115-49-2, CAS number: 2032403-97-5, CAS number: 2044701-44-0, CAS number: 2128706-05-6, CAS number: 2095470-94-1, CAS number: 2377084-09-6, CAS number: 1445683-71-5, CAS number: 2408220-94-8, CAS number: 2408220-91-5, CAS number: 1365070-72-9, CAS number: 2171099-09-3, CAS number: 2396747-83-2, CAS number: 2133042-31-4, CAS number: 2133042-44-9, CAS number: 1445684-82-1, CAS number: 1922957-45-6, CAS number: 1922957-46-7, CAS number: 1922957-47-8, CAS number: 1922957-48-9, CAS number: 2415706-16-8, CAS number: 1594624-87-9, CAS number: 1594637-65-6, CAS number: 1594626-19-3, CAS number: 1990457-52-7, CAS number: 1990457-55-0, CAS number: 1990457-57-2, CAS number: 1990457-77-6, CAS number: 1990457-66-3, CAS number: 1990457-85-6, CAS number: 2220132-55-6, CAS number: 1255091-74-7, CAS number: RNA (Leptinotarsa decemlineata-specific recombinant double-stranded interfering GS2), CAS number: 2719848-60-7, CAS number: 1956329-03-5, chlorantraniliprole, chlordane, chlorfenapyr, chloroprallethrin, chromafenozide, clenpirin, cloethocarb, clothianidin, 2-chlorophenyl N-methylcarbamate (CPMC), cyanofenphos, cyantraniliprole, cyclaniliprole, cyclobutrifluram, cycloprothrin, cycloxaprid, cyenopyrafen, cyetpyrafen (or etpyrafen), cyflumetofen, cyfluthrin, cyhalodiamide, cyhalothrin, cypermethrin, cyphenothrin, cyproflanilide, cyromazine, deltamethrin, diafenthiuron, dialifos, dibrom, dicloromezotiaz, diflovidazine, diflubenzuron, dimpropyridaz, dinactin, dinocap, dinotefuran, dioxabenzofos, emamectin (or emamectin benzoate), empenthrin, epsilon—momfluorothrin, epsilon-metofluthrin, esfenvalerate, ethion, ethiprole, etofenprox, etoxazole, famphur, fenazaquin, fenfluthrin, fenitrothion, fenmezoditiaz, fenobucarb, fenothiocarb, fenoxycarb, fenpropathrin, fenpyroximate, fensulfothion, fenthion, fentinacetate, fenvalerate, fipronil, flometoquin, flonicamid, fluacrypyrim, fluazaindolizine, fluazuron, flubendiamide, flubenzimine, fluchlordiniliprole, flucitrinate, flucycloxuron, flucythrinate, fluensulfone, flufenerim, flufenprox, flufiprole, fluhexafon, flumethrin, fluopyram, flupentiofenox flupyradifurone, flupyrimin, fluralaner, fluvalinate, fluxametamide, fosthiazate, gamma-cyhalothrin, guadipyr, halofenozide, halfenprox, heptafluthrin, hexythiazox, hydramethylnon, imicyafos, imidacloprid, imiprothrin, Indazapyroxamet, indoxacarb, iodomethane, iprodione, isocycloseram, isothioate, ivermectin, kappa-bifenthrin, kappa-tefluthrin, lambda-cyhalothrin, lepimectin, lotilaner, lufenuron, metaflumizone, metaldehyde, metam, methomyl, methoxyfenozide, metofluthrin, metolcarb, mexacarbate, milbemectin, momfluorothrin, niclosamide, nicofluprole, nitenpyram, nithiazine, omethoate, oxamyl, oxazosulfyl, parathion-ethyl, permethrin, phenothrin, phosphocarb, piperonylbutoxide, pirimicarb, pirimiphos-ethyl, pirimiphos-methyl, Polyhedrosis virus, prallethrin, profenofos, profluthrin, propargite, propetamphos, propoxur, prothiophos, protrifenbute, pyflubumide, pymetrozine, pyraclofos, pyrafluprole, pyridaben, pyridalyl, pyrifluquinazon, pyrimidifen, pyriminostrobin, pyriprole, pyriproxyfen, resmethrin, sarolaner, selamectin, silafluofen, spinetoram, spinosad, spirobudifen, spirodiclofen, spiromesifen, spiropidion, spirotetramat, spidoxamat, sulfoxaflor, tebufenozide, tebufenpyrad, tebupirimiphos, tefluthrin, temephos, tetrachlorantraniliprole, tetradiphon, tetramethrin, tetramethylfluthrin, tetranactin, tetraniliprole, theta-cypermethrin, thiacloprid, thiamethoxam, thiocyclam, thiodicarb, thiofanox, thiometon, thiosultap, tigolaner, tiorantraniliprole, tioxazafen, tolfenpyrad, toxaphene, tralomethrin, transfluthrin, triazamate, triazophos, trichlorfon, trichloronate, trichlorphon, trifluenfuronate, triflumezopyrim, tyclopyrazoflor, zeta-Cypermethrin, Extract of seaweed and fermentation product derived from melasse, Extract of seaweed and fermentation product derived from melasse comprising urea, amino acids, potassium and molybdenum and EDTA-chelated manganese, Extract of seaweed and fermented plant products, Extract of seaweed and fermented plant products comprising phytohormones, vitamins, EDTA-chelated copper, zinc, and iron, azadirachtin, Bacillus aizawai, Bacillus chitinosporus AQ746 (NRRL Accession No B-21 618), Bacillus firmus, Bacillus kurstaki, Bacillus mycoides AQ726 (NRRL Accession No. B-21664), Bacillus pumilus (NRRL Accession No B-30087), Bacillus pumilus AQ717 (NRRL Accession No. B-21662), Bacillus sp. AQ178 (ATCC Accession No. 53522), Bacillus sp. AQ175 (ATCC Accession No. 55608), Bacillus sp. AQ177 (ATCC Accession No. 55609), Bacillus subtilis unspecified, Bacillus subtilis AQ153 (ATCC Accession No. 55614), Bacillus subtilis AQ30002 (NRRL Accession No. B-50421), Bacillus subtilis AQ30004 (NRRL Accession No. B-50455), Bacillus subtilis AQ713 (NRRL Accession No. B-21661), Bacillus subtilis AQ743 (NRRL Accession No. B-21665), Bacillus thuringiensis AQ52 (NRRL Accession No. B-21619), Bacillus thuringiensis BD #32 (NRRL Accession No B-21530), Bacillus thuringiensis subspec. kurstaki BMP 123, Beauveria bassiana, D-limonene, Granulovirus, Harpin, Helicoverpa armigera Nucleopolyhedrovirus, Helicoverpa zea Nucleopolyhedrovirus, Heliothis virescens Nucleopolyhedrovirus, Heliothis punctigera Nucleopolyhedrovirus, Metarhizium spp., Muscodor albus 620 (NRRL Accession No. 30547), Muscodor roseus A3-5 (NRRL Accession No. 30548), Neem tree based products, Paecilomyces fumosoroseus, Paecilomyces lilacinus, Pasteuria nishizawae, Pasteuria penetrans, Pasteuria ramosa, Pasteuria thornei, Pasteuria usgae, P-cymene, Plutella xylostella Granulosis virus, Plutella xylostella Nucleopolyhedrovirus, Polyhedrosis virus, pyrethrum, QRD 420 (a terpenoid blend), QRD 452 (a terpenoid blend), QRD 460 (a terpenoid blend), Quillaja saponaria, Rhodococcus globerulus AQ719 (NRRL Accession No B-21663), Spodoptera frugiperda Nucleopolyhedrovirus, Streptomyces galbus (NRRL Accession No. 30232), Streptomyces sp. (NRRL Accession No. B-30145), terpenoid blend, and Verticillium spp.;
an algicide selected from the group of substances consisting of bethoxazin, copper dioctanoate (170), copper sulfate (172), cybutryne, dichlone (1052), dichlorophen (232), endothal (295), fentin (347), hydrated lime, nabam (566), quinoclamine (714), quinonamid (1379), simazine (730), triphenyltin acetate (347) and triphenyltin hydroxide (347);
an anthelmintic selected from the group of substances consisting of abamectin (1), crufomate (1011), doramectin, emamectin (291), emamectin benzoate (291), eprinomectin, ivermectin, milbemycin oxime, moxidectin, piperazine, selamectin, spinosad (737) and thiophanate (1435);
an avicide selected from the group of substances consisting of chloralose (127), endrin (1122), fenthion (346), pyridin-4-amine (23) and strychnine (745);
a bactericide selected from the group of substances consisting of 1-hydroxy-1H-pyridine-2-thione (1222), 4-(quinoxalin-2-ylamino)benzenesulfonamide (748), 8-hydroxyquinoline sulfate (446), bronopol (97), copper dioctanoate (170), copper hydroxide (169), cresol, dichlorophen (232), dipyrithione (1105), dodicin (1112), fenaminosulf (1144), formaldehyde (404), hydrargaphen, kasugamycin (483), kasugamycin hydrochloride hydrate (483), nickel bis(dimethyldithiocarbamate) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766), and thiomersal;
a biological agent selected from the group of substances consisting of Adoxophyes orana GV (12), Agrobacterium radiobacter (13), Amblyseius spp. (19), Anagrapha falcifera NPV (28), Anagrus atomus (29), Aphelinus abdominalis (33), Aphidius colemani (34), Aphidoletes aphidimyza (35), Autographa californica NPV (38), Bacillus firmus (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (53), Beauveria brongniartii (54), Chrysoperla carnea (151), Cryptolaemus montrouzieri (178), Cydia pomonella GV (191), Dacnusa sibirica (212), Diglyphus isaea (254), Encarsia formosa (scientific name) (293), Eretmocerus eremicus (300), Helicoverpa zea NPV (431), Heterorhabditis bacteriophora and H. megidis (433), Hippodamia convergens (442), Leptomastix dactylopii (488), Macrolophus caliginosus (491), Mamestra brassicae NPV (494), Metaphycus helvolus (522), Metarhizium anisopliae var. acridum (scientific name) (523), Metarhizium anisopliae var. anisopliae (scientific name) (523), Neodiprion sertifer NPV and N. lecontei NPV (575), Orius spp. (596), Paecilomyces fumosoroseus (613), Phytoseiulus persimilis (644), Spodoptera exigua multicapsid nuclear polyhedrosis virus (scientific name) (741), Steinernema bibionis (742), Steinernema carpocapsae (742), Steinernema feltiae (742), Steinernema glaseri (742), Steinernema riobrave (742), Steinernema riobravis (742), Steinernema scapterisci (742), Steinernema spp. (742), Trichogramma spp. (826), Typhlodromus occidentalis (844) and Verticillium lecanii (848);
a soil sterilant selected from the group of substances consisting of iodomethane (542) and methyl bromide (537);
a chemosterilant selected from the group of substances consisting of apholate, bisazir, busulfan, diflubenzuron (250), dimatif, hemel, hempa, metepa, methiotepa, methyl apholate, morzid, penfluron, tepa, thiohempa, thiotepa, tretamine and uredepa;
an insect pheromone selected from the group of substances consisting of (E)-dec-5-en-1-yl acetate with (E)-dec-5-en-1-ol (222), (E)-tridec-4-en-1-yl acetate (829), (E)-6-methylhept-2-en-4-ol (541), (E,Z)-tetradeca-4,10-dien-1-yl acetate (779), (Z)-dodec-7-en-1-yl acetate (285), (Z)-hexadec-11-enal (436), (Z)-hexadec-11-en-1-yl acetate (437), (Z)-hexadec-13-en-11-yn-1-yl acetate (438), (Z)-icos-13-en-10-one (448), (Z)-tetradec-7-en-1-al (782), (Z)-tetradec-9-en-1-ol (783), (Z)-tetradec-9-en-1-yl acetate (784), (7E,9Z)-dodeca-7,9-dien-1-yl acetate (283), (9Z,11E)-tetradeca-9,11-dien-1-yl acetate (780), (9Z,12E)-tetradeca-9,12-dien-1-yl acetate (781), 14-methyloctadec-1-ene (545), 4-methylnonan-5-ol with 4-methylnonan-5-one (544), alpha-multistriatin, brevicomin, codlelure, codlemone (167), cuelure (179), disparlure (277), dodec-8-en-1-yl acetate (286), dodec-9-en-1-yl acetate (287), dodeca-8, 10-dien-1-yl acetate (284), dominicalure, ethyl 4-methyloctanoate (317), eugenol, frontalin, Gossyplure® (alternative name; 1:1 mixture of the (Z,E) and (Z,Z) isomers of hexadeca-7,11-dien-1-yl-acetate) (420), grandlure (421), grandlure I (421), grandlure II (421), grandlure 111 (421), grandlure IV (421), hexalure, ipsdienol, ipsenol, japonilure (481), lineatin, litlure, looplure, medlure, megatomoic acid, methyl eugenol (540), muscalure (563), octadeca-2,13-dien-1-yl acetate (588), octadeca-3,13-dien-1-yl acetate (589), orfralure, oryctalure (317), ostramone, siglure, sordidin (736), sulcatol, tetradec-11-en-1-yl acetate (785), trimedlure (839), trimedlure A (839), trimedlure B1 (839), trimedlure B2 (839), trimedlure C (839) and trunc-call;
an insect repellent selected from the group of substances consisting of 2-(octylthio)ethanol (591), butopyronoxyl (933), butoxy(polypropylene glycol) (936), dibutyl adipate (1046), dibutyl phthalate (1047), dibutyl succinate (1048), diethyltoluamide, dimethyl carbate, dimethyl phthalate, ethyl hexanediol (1137), hexamide, methoquin-butyl (1276), methylneodecanamide, oxamate and picaridin;
a molluscicide selected from the group of substances consisting of bis(tributyltin) oxide (913), bromoacetamide, calcium arsenate, cloethocarb (999), copper acetoarsenite, copper sulfate (172), fentin (347), ferric phosphate (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (347) and triphenyltin hydroxide (347), pyriprole [394730-71-3]; a nematicide selected from the group of substances consisting of AKD-3088 (compound code), 1,2-dibromo-3-chloropropane (1045), 1,2-dichloropropane (IUPAC/Chemical Abstracts name) (1062), 1,2-dichloropropane with 1,3-dichloropropene (1063), 1,3-dichloropropene (233), 3,4-dichlorotetrahydrothiophene 1,1-dioxide (1065), 3-(4-chlorophenyl)-5-methylrhodanine (980), 5-methyl-6-thioxo-1,3,5-thiadiazinan-3-ylacetic acid (1286), 6-isopentenylaminopurine (210), abamectin (1), acetoprole, alanycarb (15), aldicarb (16), aldoxycarb (863), AZ 60541 (compound code), benclothiaz, benomyl (62), butylpyridaben, cadusafos (109), carbofuran (118), carbon disulfide (945), carbosulfan (119), chloropicrin (141), chlorpyrifos (145), cloethocarb (999), cytokinins (210), dazomet (216), DBCP (1045), DCIP (218), diamidafos (1044), dichlofenthion (1051), dicliphos, dimethoate (262), doramectin, emamectin (291), emamectin benzoate (291), eprinomectin, ethoprophos (312), ethylene dibromide (316), fenamiphos (326), fenpyrad, fensulfothion (1158), fosthiazate (408), fosthietan (1196), furfural, GY-81 (development code) (423), heterophos, iodomethane (542), isamidofos (1230), isazofos (1231), ivermectin, kinetin (210), mecarphon (1258), metam (519), metam-potassium (519), metam-sodium (519), methyl bromide (537), methyl isothiocyanate (543), milbemycin oxime, moxidectin, Myrothecium verrucaria composition (565), NC-184 (compound code), oxamyl (602), phorate (636), phosphamidon (639), phosphocarb, sebufos, selamectin, spinosad (737), terbam, terbufos (773), tetrachlorothiophene (IUPAC/Chemical Abstracts name) (1422), thiafenox, thionazin (1434), triazophos (820), triazuron, xylenols, YI-5302 (compound code) and zeatin (210), fluensulfone [318290-98-1], fluopyram;
a nitrification inhibitor selected from the group of substances consisting of potassium ethylxanthate and nitrapyrin (580);
a plant activator selected from the group of substances consisting of acibenzolar (6), acibenzolar-S-methyl (6), probenazole (658) and Reynoutria sachalinensis extract (720);
a rodenticide selected from the group of substances consisting of 2-isovalerylindan-1,3-dione (1246), 4-(quinoxalin-2-ylamino)benzenesulfonamide (748), alpha-chlorohydrin, aluminium phosphide (640), antu (880), arsenous oxide (882), barium carbonate (891), bisthiosemi (912), brodifacoum (89), bromadiolone (or alpha-bromadiolone), bromethalin (92), calcium cyanide (444), chloralose (127), chlorophacinone (140), cholecalciferol (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyanide (444), iodomethane (542), lindane (430), magnesium phosphide (640), methyl bromide (537), norbormide (1318), phosacetim (1336), phosphine (640), phosphorus, pindone (1341), potassium arsenite, pyrinuron (1371), scilliroside (1390), sodium arsenite, sodium cyanide (444), sodium fluoroacetate (735), strychnine (745), thallium sulfate, warfarin (851) and zinc phosphide (640);
a synergist selected from the group of substances consisting of 2-(2-butoxyethoxy)ethyl piperonylate (934), 5-(1,3-benzodioxol-5-yl)-3-hexylcyclohex-2-enone (903), farnesol with nerolidol (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate, copper oxychloride (171), diazinon (227), dicyclopentadiene (chemical name) (1069), guazatine (422), guazatine acetates (422), methiocarb (530), pyridin-4-amine (23), thiram (804), trimethacarb (840), zinc naphthenate and ziram (856);
a virucide selected from the group of substances consisting of imanin and ribavirin;
a wound protectant selected from the group of substances consisting of mercuric oxide (512), octhilinone (590) and thiophanate-methyl (802);
a biologically active substance selected from 1,1-bis(4-chloro-phenyl)-2-ethoxyethanol, 2,4-dichlorophenyl benzenesulfonate, 2-fluoro-N-methyl-N-1-naphthylacetamide, 4-chlorophenyl phenyl sulfone, acetoprole, aldoxycarb, amidithion, amidothioate, amiton, amiton hydrogen oxalate, amitraz, aramite, arsenous oxide, azobenzene, azothoate, benomyl, benoxa-fos, benzyl benzoate, bixafen, brofenvalerate, bromo-cyclen, bromophos, bromopropylate, buprofezin, butocarboxim, butoxycarboxim, butylpyridaben, calcium polysulfide, camphechlor, carbanolate, carbophenothion, cymiazole, chino-methionat, chlorbenside, chlordimeform, chlordimeform hydrochloride, chlorfenethol, chlorfenson, chlorfensulfide, chlorobenzilate, chloromebuform, chloromethiuron, chloropropylate, chlorthiophos, cinerin I, cinerin II, cinerins, closantel, coumaphos, crotamiton, crotoxyphos, cufraneb, cyanthoate, DCPM, DDT, demephion, demephion-O, demephion-S, demeton-methyl, demeton-O, demeton-O-methyl, demeton-S, demeton-S-methyl, demeton-S-methylsulfon, dichlofluanid, dichlorvos, dicliphos, dienochlor, dimefox, dinex, dinex-diclexine, dinocap-4, dinocap-6, dinocton, dino-penton, dinosulfon, dinoterbon, dioxathion, diphenyl sulfone, disulfiram, DNOC, dofenapyn, doramectin, endothion, eprinomectin, ethoate-methyl, etrimfos, fenazaflor, fenbutatin oxide, fenothiocarb, fenpyrad, fen-pyroximate, fenpyrazamine, fenson, fentrifanil, flubenzimine, flucycloxuron, fluenetil, fluorbenside, FMC 1137, formetanate, formetanate hydrochloride, formparanate, gamma-HCH, glyodin, halfenprox, hexadecyl cyclopropanecarboxylate, isocarbophos, jasmolin I, jasmolin II, jodfenphos, lindane, malonoben, mecarbam, mephosfolan, mesulfen, methacrifos, methyl bromide, metolcarb, mexacarbate, milbemycin oxime, mipafox, monocrotophos, morphothion, moxidectin, naled, 4-chloro-2-(2-chloro-2-methyl-propyl)-5-[(6-iodo-3-pyridyl)methoxy]pyridazin-3-one, nifluridide, nikkomycins, nitrilacarb, nitrilacarb 1:1 zinc chloride complex, omethoate, oxydeprofos, oxydisulfoton, pp′-DDT, parathion, permethrin, phenkapton, phosalone, phosfolan, phosphamidon, polychloroterpenes, polynactins, proclonol, promacyl, propoxur, prothidathion, prothoate, pyrethrin I, pyrethrin II, pyrethrins, pyridaphenthion, pyrimitate, quinalphos, quintiofos, R-1492, phosglycin, rotenone, schradan, sebufos, selamectin, sophamide, SSI-121, sulfiram, sulfluramid, sulfotep, sulfur, diflovidazin, tau-fluvalinate, TEPP, terbam, tetradifon, tetrasul, thiafenox, thiocarboxime, thiofanox, thiometon, thioquinox, thuringiensin, triamiphos, triarathene, triazophos, triazuron, trifenofos, trinactin, vamidothion, vaniliprole, bethoxazin, copper dioctanoate, copper sulfate, cybutryne, dichlone, dichlorophen, endothal, fentin, hydrated lime, nabam, quinoclamine, quinonamid, simazine, triphenyltin acetate, triphenyltin hydroxide, crufomate, piperazine, thiophanate, chloralose, fenthion, pyridin-4-amine, strychnine, 1-hydroxy-1H-pyridine-2-thione, 4-(quinoxalin-2-ylamino)benzenesulfonamide, 8-hydroxyquinoline sulfate, bronopol, copper hydroxide, cresol, dipyrithione, dodicin, fenaminosulf, formaldehyde, hydrargaphen, kasugamycin, kasugamycin hydrochloride hydrate, nickel bis(dimethyldithiocarbamate), nitrapyrin, octhilinone, oxolinic acid, oxytetracycline, potassium hydroxyquinoline sulfate, probenazole, streptomycin, streptomycin sesquisulfate, tecloftalam, thiomersal, Adoxophyes orana GV, Agrobacterium radiobacter, Amblyseius spp., Anagrapha falcifera NPV, Anagrus atomus, Aphelinus abdominalis, Aphidius colemani, Aphidoletes aphidimyza, Autographa californica NPV, Bacillus sphaericus Neide, Beauveria brongniartii, Chrysoperla carnea, Cryptolaemus montrouzieri, Cydia pomonella GV, Dacnusa sibirica, Diglyphus isaea, Encarsia formosa, Eretmocerus eremicus, Heterorhabditis bacteriophora and H. megidis, Hippodamia convergens, Leptomastix dactylopii, Macrolophus caliginosus, Mamestra brassicae NPV, Metaphycus helvolus, Metarhizium anisopliae var. acridum, Metarhizium anisopliae var. anisopliae, Neodiprion sertifer NPV and N. lecontei NPV, Orius spp., Paecilomyces fumosoroseus, Phytoseiulus persimilis, Steinernema bibionis, Steinernema carpocapsae, Steinernema feltiae, Steinernema glaseri, Steinernema riobrave, Steinernema riobravis, Steinernema scapterisci, Steinernema spp., Trichogramma spp., Typhlodromus occidentalis, Verticillium lecanii, apholate, bisazir, busulfan, dimatif, hemel, hempa, metepa, methiotepa, methyl apholate, morzid, penfluron, tepa, thiohempa, thiotepa, tretamine, uredepa, (E)-dec-5-en-1-yl acetate with (E)-dec-5-en-1-ol, (E)-tridec-4-en-1-yl acetate, (E)-6-methylhept-2-en-4-ol, (E,Z)-tetradeca-4,10-dien-1-yl acetate, (Z)-dodec-7-en-1-yl acetate, (Z)-hexadec-11-enal, (Z)-hexadec-11-en-1-yl acetate, (Z)-hexadec-13-en-11-yn-1-yl acetate, (Z)-icos-13-en-10-one, (Z)-tetradec-7-en-1-al, (Z)-tetradec-9-en-1-ol, (Z)-tetradec-9-en-1-yl acetate, (7E,9Z)-dodeca-7,9-dien-1-yl acetate, (9Z,11E)-tetradeca-9,11-dien-1-yl acetate, (9Z,12E)-tetradeca-9,12-dien-1-yl acetate, 14-methyloctadec-1-ene, 4-methylnonan-5-ol with 4-methylnonan-5-one, alpha-multistriatin, brevicomin, codlelure, codlemone, cuelure, disparlure, dodec-8-en-1-yl acetate, dodec-9-en-1-yl acetate, dodeca-8, 10-dien-1-yl acetate, dominicalure, ethyl 4-methyloctanoate, eugenol, frontalin, grandlure, grandlure I, grandlure II, grandlure Ill, grandlure IV, hexalure, ipsdienol, ipsenol, japonilure, lineatin, litlure, looplure, medlure, megatomoic acid, methyl eugenol, muscalure, octadeca-2,13-dien-1-yl acetate, octadeca-3,13-dien-1-yl acetate, orfralure, oryctalure, ostramone, siglure, sordidin, sulcatol, tetradec-11-en-1-yl acetate, trimedlure, trimedlure A, trimedlure B1, trimedlure B2, trimedlure C, trunc-call, 2-(octylthio)-ethanol, butopyronoxyl, butoxy(polypropylene glycol), dibutyl adipate, dibutyl phthalate, dibutyl succinate, diethyltoluamide, dimethyl carbate, dimethyl phthalate, ethyl hexanediol, hexamide, methoquin-butyl, methylneodecanamide, oxamate, picaridin, 1-dichloro-1-nitroethane, 1,1-dichloro-2,2-bis(4-ethylphenyl)-ethane, 1,2-dichloropropane with 1,3-dichloropropene, 1-bromo-2-chloroethane, 2,2,2-trichloro-1-(3,4-dichloro-phenyl)ethyl acetate, 2,2-dichlorovinyl 2-ethylsulfinylethyl methyl phosphate, 2-(1,3-dithiolan-2-yl)phenyl dimethylcarbamate, 2-(2-butoxyethoxy)ethyl thiocyanate, 2-(4,5-dimethyl-1,3-dioxolan-2-yl)phenyl methylcarbamate, 2-(4-chloro-3,5-xylyloxy)ethanol, 2-chlorovinyl diethyl phosphate, 2-imidazolidone, 2-isovalerylindan-1,3-dione, 2-methyl(prop-2-ynyl)aminophenyl methylcarbamate, 2-thiocyanatoethyl laurate, 3-bromo-1-chloroprop-1-ene, 3-methyl-1-phenylpyrazol-5-yl dimethyl-carbamate, 4-methyl(prop-2-ynyl)amino-3,5-xylyl methylcarbamate, 5,5-dimethyl-3-oxocyclohex-1-enyl dimethylcarbamate, acethion, acrylonitrile, aldrin, allosamidin, allyxycarb, alpha-ecdysone, aluminium phosphide, aminocarb, anabasine, athidathion, azamethiphos, Bacillus thuringiensis delta endotoxins, barium hexafluorosilicate, barium polysulfide, barthrin, Bayer 22/190, Bayer 22408, beta-cyfluthrin, beta-cypermethrin, bioethanomethrin, biopermethrin, bis(2-chloroethyl) ether, borax, bromfenvinfos, bromo-DDT, bufencarb, butacarb, butathiofos, butonate, calcium arsenate, calcium cyanide, carbon disulfide, carbon tetrachloride, cartap hydrochloride, cevadine, chlorbicyclen, chlordane, chlordecone, chloroform, chloropicrin, chlorphoxim, chlorprazophos, cis-resmethrin, cismethrin, clocythrin, copper acetoarsenite, copper arsenate, copper oleate, coumithoate, cryolite, CS 708, cyanofenphos, cyanophos, cyclethrin, cythioate, d-tetramethrin, DAEP, dazomet, decarbofuran, diamidafos, dicapthon, dichlofenthion, dicresyl, dicyclanil, dieldrin, diethyl 5-methylpyrazol-3-yl phosphate, dilor, dimefluthrin, dimetan, dimethrin, dimethylvinphos, dimetilan, dinoprop, dinosam, dinoseb, diofenolan, dioxabenzofos, dithicrofos, DSP, ecdysterone, El 1642, EMPC, EPBP, etaphos, ethiofencarb, ethyl formate, ethylene dibromide, ethylene dichloride, ethylene oxide, EXD, fenchlorphos, fenethacarb, fenitrothion, fenoxacrim, fenpirithrin, fensulfothion, fenthion-ethyl, flucofuron, fosmethilan, fospirate, fosthietan, furathiocarb, furethrin, guazatine, guazatine acetates, sodium tetrathiocarbonate, halfenprox, HCH, HEOD, heptachlor, heterophos, HHDN, hydrogen cyanide, hyquincarb, IPSP, isazofos, isobenzan, isodrin, isofenphos, isolane, isoprothiolane, isoxathion, juvenile hormone I, juvenile hormone II, juvenile hormone Ill, kelevan, kinoprene, lead arsenate, leptophos, lirimfos, lythidathion, m-cumenyl methylcarbamate, magnesium phosphide, mazidox, mecarphon, menazon, mercurous chloride, mesulfenfos, metam, metam-potassium, metam-sodium, methanesulfonyl fluoride, methocrotophos, methoprene, methothrin, methoxychlor, methyl isothiocyanate, methylchloroform, methylene chloride, metoxadiazone, mirex, naftalofos, naphthalene, NC-170, nicotine, nicotine sulfate, nithiazine, nornicotine, O-5-dichloro-4-iodophenyl O-ethyl ethylphosphonothioate, O,O-diethyl O-4-methyl-2-oxo-2H-chromen-7-yl phosphorothioate, O,O-diethyl O-6-methyl-2-propylpyrimidin-4-yl phosphorothioate, O,O,O′,O′-tetrapropyl dithiopyrophosphate, oleic acid, para-dichlorobenzene, parathion-methyl, pentachlorophenol, pentachlorophenyl laurate, PH 60-38, phenkapton, phosnichlor, phosphine, phoxim-methyl, pirimetaphos, polychlorodicyclopentadiene isomers, potassium arsenite, potassium thiocyanate, precocene I, precocene II, precocene III, primidophos, profluthrin, promecarb, prothiofos, pyrazophos, pyresmethrin, quassia, quinalphos-methyl, quinothion, rafoxanide, resmethrin, rotenone, kadethrin, ryania, ryanodine, sabadilla, schradan, sebufos, SI-0009, thiapronil, sodium arsenite, sodium cyanide, sodium fluoride, sodium hexafluorosilicate, sodium pentachlorophenoxide, sodium selenate, sodium thiocyanate, sulcofuron, sulcofuron-sodium, sulfuryl fluoride, sulprofos, tar oils, tazimcarb, TDE, tebupirimfos, temephos, terallethrin, tetrachloroethane, thicrofos, thiocyclam, thiocyclam hydrogen oxalate, thionazin, thiosultap, thiosultap-sodium, tralomethrin, transpermethrin, triazamate, trichlormetaphos-3, trichloronat, trimethacarb, tolprocarb, triclopyricarb, triprene, veratridine, veratrine, XMC, zetamethrin, zinc phosphide, zolaprofos, meperfluthrin, tetramethylfluthrin, bis(tributyltin) oxide, bromoacetamide, ferric phosphate, niclosamide-olamine, tributyltin oxide, pyrimorph, trifenmorph, 1,2-dibromo-3-chloropropane, 1,3-dichloropropene, 3,4-dichlorotetrahydrothio-phene 1,1-dioxide, 3-(4-chlorophenyl)-5-methylrhodanine, 5-methyl-6-thioxo-1,3,5-thiadiazinan-3-ylacetic acid, 6-isopentenylaminopurine, anisiflupurin, benclothiaz, cytokinins, DCIP, furfural, isamidofos, kinetin, Myrothecium verrucaria composition, tetrachlorothiophene, xylenols, zeatin, potassium ethylxanthate, acibenzolar, acibenzolar-S-methyl, Reynoutria sachalinensis extract, alpha-chlorohydrin, antu, barium carbonate, bisthiosemi, brodifacoum, bromadiolone, bromethalin, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, norbormide, phosacetim, phosphorus, pindone, pyrinuron, scilliroside, sodium fluoro-acetate, thallium sulfate, warfarin, 2-(2-butoxyethoxy)-ethyl piperonylate, 5-(1,3-benzodioxol-5-yl)-3-hexylcyclohex-2-enone, farnesol with nerolidol, verbutin, MGK 264, piperonyl butoxide, piprotal, propyl isomer, S421, sesamex, sesasmolin, sulfoxide, anthraquinone, copper naphthenate, copper oxychloride, dicyclopentadiene, thiram, zinc naphthenate, ziram, imanin, ribavirin, chloroinconazide, mercuric oxide, thiophanate-methyl, azaconazole, bitertanol, bromuconazole, cyproconazole, difenoconazole, diniconazole, epoxicon-azole, fenbuconazole, fluquinconazole, flusilazole, flutriafol, furametpyr, hexaconazole, imazalil, imiben-con-azole, ipconazole, metconazole, myclobutanil, paclobutrazole, pefurazoate, penconazole, prothioconazole, pyrifenox, prochloraz, propiconazole, pyrisoxazole, simeconazole, tebucon-azole, tetraconazole, triadimefon, triadime-nol, triflumizole, triticonazole, ancymidol, fenarimol, nuarimol, bupirimate, dimethirimol, ethirimol, dodemorph, fenpropidin, fenpropimorph, spiroxamine, tridemorph, cyprodinil, mepanipyrim, pyrimethanil, fenpiclonil, fludioxonil, benalaxyl, furalaxyl, meta-laxyl, R-metalaxyl, ofurace, oxadixyl, carbendazim, debacarb, fuberidazole, thiaben-dazole, chlozolinate, dichlozoline, myclozoline, procymi-done, vinclozoline, boscalid, carboxin, fenfuram, flutolanil, mepronil, oxycarboxin, penthiopyrad, thifluzamide, dodine, iminoctadine, azoxystrobin, dimoxystrobin, enestroburin, fenaminstrobin, flufenoxystrobin, fluoxastrobin, kresoxim-methyl, metomi-nostrobin, trifloxystrobin, orysastrobin, picoxystrobin, pyraclostrobin, pyrametostrobin, pyraoxystrobin, ferbam, mancozeb, maneb, metiram, propineb, zineb, captafol, captan, fluoroimide, folpet, tolylfluanid, bordeaux mixture, copper oxide, mancopper, oxine-copper, nitrothal-isopropyl, edifenphos, iprobenphos, phosdiphen, tolclofos-methyl, anilazine, benthiavalicarb, blasticidin-S, chloroneb, chloro-tha-lo-nil, cyflufenamid, cymoxanil, cyclobutrifluram, diclocymet, diclomezine, dicloran, diethofencarb, dimetho-morph, flumorph, dithianon, ethaboxam, etridiazole, famoxa-done, fenamidone, fenoxanil, ferimzone, fluazinam, flumetylsulforim, fluopicolide, fluoxytioconazole, flusulfamide, fluxapyroxad, fenhexamid, fos-etyl-aluminium, hymexazol, iprovalicarb, cyazofamid, methasulfo-carb, metrafenone, pencycuron, phthalide, polyoxins, propamocarb, pyribencarb, proquinazid, pyroquilon, pyriofenone, quinoxyfen, quintozene, tiadinil, triazoxide, tricyclazole, triforine, validamycin, valifenalate, zoxamide, mandipropamid, flubeneteram, isopyrazam, sedaxane, benzovindiflupyr, pydiflumetofen, 3-difluoromethyl-1-methyl-1H-pyrazole-4-carboxylic acid (3′,4′,5′-trifluoro-biphenyl-2-yl)-amide, isoflucypram, isotianil, dipymetitrone, 6-ethyl-5,7-dioxo-pyrrolo[4,5][1,4]dithiino[1,2-c]isothiazole-3-carbonitrile, 2-(difluoromethyl)-N-[3-ethyl-1,1-dimethyl-indan-4-yl]pyridine-3-carboxamide, 4-(2,6-difluorophenyl)-6-methyl-5-phenyl-pyridazine-3-carbonitrile, (R)-3-(difluoromethyl)-1-methyl-N-[1,1,3-trimethylindan-4-yl]pyrazole-4-carboxamide, 4-(2-bromo-4-fluoro-phenyl)-N-(2-chloro-6-fluoro-phenyl)-2,5-dimethyl-pyrazol-3-amine, 4-(2-bromo-4-fluorophenyl)-N-(2-chloro-6-fluorophenyl)-1,3-dimethyl-1H-pyrazol-5-amine, fluindapyr, coumethoxystrobin (jiaxiangjunzhi), Ivbenmixianan, dichlobentiazox, mandestrobin, 3-(4,4-difluoro-3,4-dihydro-3,3-dimethylisoquinolin-1-yl)quinolone, 2-[2-fluoro-6-[(8-fluoro-2-methyl-3-quinolyl)oxy]phenyl]propan-2-ol, oxathiapiprolin, tert-butyl N-[6-[[[(1-methyltetrazol-5-yl)-phenyl-methylene]amino]oxymethyl]-2-pyridyl]carbamate, pyraziflumid, inpyrfluxam, trolprocarb, mefentrifluconazole, ipfentrifluconazole, 2-(difluoromethyl)-N-[(3R)-3-ethyl-1,1-dimethyl-indan-4-yl]pyridine-3-carboxamide, N′-(2,5-dimethyl-4-phenoxy-phenyl)-N-ethyl-N-methyl-formamidine, N′-[4-(4,5-dichlorothiazol-2-yl)oxy-2,5-dimethyl-phenyl]-N-ethyl-N-methyl-formamidine, [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl]methanesulfonate, but-3-ynyl N-[6-[[(Z)-[(1-methyltetrazol-5-yl)-phenyl-methylene]amino]oxymethyl]-2-pyridyl]carbamate, methyl N-[[5-[4-(2,4-dimethylphenyl)triazol-2-yl]-2-methyl-phenyl]methyl]carbamate, 3-chloro-6-methyl-5-phenyl-4-(2,4,6-trifluorophenyl)pyridazine, pyridachlometyl, 3-(difluoromethyl)-1-methyl-N-[1,1,3-trimethylindan-4-yl]pyrazole-4-carboxamide, 1-[2-[[1-(4-chlorophenyl)pyrazol-3-yl]oxymethyl]-3-methyl-phenyl]-4-methyl-tetrazol-5-one, 1-methyl-4-[3-methyl-2-[[2-methyl-4-(3,4,5-trimethylpyrazol-1-yl)phenoxy]methyl]phenyl]tetrazol-5-one, aminopyrifen, ametoctradin, amisulbrom, penflufen, (Z,2E)-5-[1-(4-chlorophenyl)pyrazol-3-yl]oxy-2-methoxyimino-N,3-dimethyl-pent-3-enamide, florylpicoxamid, fenpicoxamid, metarylpicoxamid, tebufloquin, ipflufenoquin, quinofumelin, isofetamid, ethyl 1-[[4-[[2-(trifluoromethyl)-1,3-dioxolan-2-yl]methoxy]phenyl]methyl]pyrazole-3-carboxylate (may be prepared from the methods described in WO 2020/056090), ethyl 1-[[4-[(Z)-2-ethoxy-3,3,3-trifluoro-prop-1-enoxy]phenyl]methyl]pyrazole-3-carboxylate (may be prepared from the methods described in WO 2020/056090), methyl N-[[4-[1-(4-cyclopropyl-2,6-difluoro-phenyl)pyrazol-4-yl]-2-methyl-phenyl]methyl]carbamate (may be prepared from the methods described in WO 2020/097012), methyl N-[[4-[1-(2,6-difluoro-4-isopropyl-phenyl)pyrazol-4-yl]-2-methyl-phenyl]methyl]carbamate (may be prepared from the methods described in WO 2020/097012), 6-chloro-3-(3-cyclopropyl-2-fluoro-phenoxy)-N-[2-(2,4-dimethylphenyl)-2,2-difluoro-ethyl]-5-methyl-pyridazine-4-carboxamide (may be prepared from the methods described in WO 2020/109391), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide (may be prepared from the methods described in WO 2020/109391), 6-chloro-3-(3-cyclopropyl-2-fluoro-phenoxy)-N-[2-(3,4-dimethylphenyl)-2,2-difluoro-ethyl]-5-methyl-pyridazine-4-carboxamide (may be prepared from the methods described in WO 2020/109391), N-[2-[2,4-dichloro-phenoxy]phenyl]-3-(difluoromethyl)-1-methyl-pyrazole-4-carboxamide, N-[2-[2-chloro-4-(trifluoromethyl)phenoxy]phenyl]-3-(difluoromethyl)-1-methyl-pyrazole-4-carboxamide, benzothiostrobin, phenamacril, 5-amino-1,3,4-thiadiazole-2-thiol zinc salt (2:1), fluopyram, flufenoxadiazam, flutianil, fluopimomide, pyrapropoyne, picarbutrazox, 2-(difluoromethyl)-N-(3-ethyl-1,1-dimethyl-indan-4-yl)pyridine-3-carboxamide, 2-(difluoromethyl)-N-((3R)-1, 1, 3-trimethylindan-4-yl) pyridine-3-carboxamide, 4-[[6-[2-(2,4-difluorophenyl)-1,1-difluoro-2-hydroxy-3-(1,2,4-triazol-1-yl)propyl]-3-pyridyl]oxy]benzonitrile, metyltetraprole, 2-(difluoromethyl)-N-((3R)-1, 1, 3-trimethylindan-4-yl) pyridine-3-carboxamide, α-(1, 1-dimethylethyl)-α-[4′-(trifluoromethoxy) [1, 1-biphenyl]-4-yl]-5-pyrimidinemethanol, fluoxapiprolin, enoxastrobin, methyl (Z)-3-methoxy-2-[2-methyl-5-[4-(trifluoromethyl)triazol-2-yl]phenoxy]prop-2-enoate, methyl (Z)-3-methoxy-2-[2-methyl-5-(4-propyltriazol-2-yl)phenoxy]prop-2-enoate, methyl (Z)-2-[5-(3-isopropylpyrazol-1-yl)-2-methyl-phenoxy]-3-methoxy-prop-2-enoate, methyl (Z)-3-methoxy-2-[2-methyl-5-(3-propylpyrazol-1-yl)phenoxy]prop-2-enoate, methyl (Z)-3-methoxy-2-[2-methyl-5-[3-(trifluoromethyl)pyrazol-1-yl]phenoxy]prop-2-enoate (these compounds may be prepared from the methods described in WO2020/079111), methyl (Z)-2-(5-cyclohexyl-2-methyl-phenoxy)-3-methoxy-prop-2-enoate, methyl (Z)-2-(5-cyclopentyl-2-methyl-phenoxy)-3-methoxy-prop-2-enoate (these compounds may be prepared from the methods described in WO2020/193387), 4-[[6-[2-(2,4-difluorophenyl)-1,1-difluoro-2-hydroxy-3-(1,2,4-triazol-1-yl)propyl]-3-pyridyl]oxy]benzonitrile, 4-[[6-[2-(2,4-difluorophenyl)-1,1-difluoro-2-hydroxy-3-(5-sulfanyl-1,2,4-triazol-1-yl)propyl]-3-pyridyl]oxy]benzonitrile, 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile, trinexapac, coumoxystrobin, zhongshengmycin, thiodiazole copper, zinc thiazole, amectotractin, iprodione, seboctylamine, N′-[5-bromo-2-methyl-6-[(1S)-1-methyl-2-propoxy-ethoxy]-3-pyridyl]-N-ethyl-N-methyl-formamidine, N′-[5-bromo-2-methyl-6-[(1R)-1-methyl-2-propoxy-ethoxy]-3-pyridyl]-N-ethyl-N-methyl-formamidine, N′-[5-bromo-2-methyl-6-(1-methyl-2-propoxy-ethoxy)-3-pyridyl]-N-ethyl-N-methyl-formamidine, N′-[5-chloro-2-methyl-6-(1-methyl-2-propoxy-ethoxy)-3-pyridyl]-N-ethyl-N-methyl-formamidine, N′-[5-bromo-2-methyl-6-(1-methyl-2-propoxy-ethoxy)-3-pyridyl]-N-isopropyl-N-methyl-formamidine (these compounds may be prepared from the methods described in WO2015/155075); N′-[5-bromo-2-methyl-6-(2-propoxypropoxy)-3-pyridyl]-N-ethyl-N-methyl-formamidine (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine, N′-[4-(1-cyclopropyl-2,2,2-trifluoro-1-hydroxy-ethyl)-5-methoxy-2-methyl-phenyl]-N-isopropyl-N-methyl-formamidine (these compounds may be prepared from the methods described in WO2018/228896); N-ethyl-N′-[5-methoxy-2-methyl-4-[(2-trifluoromethyl)oxetan-2-yl]phenyl]-N-methyl-formamidine, N-ethyl-N′-[5-methoxy-2-methyl-4-[(2-trifuoromethyl)tetrahydrofuran-2-yl]phenyl]-N-methyl-formamidine (these compounds may be prepared from the methods described in WO2019/110427); N-[(1R)-1-benzyl-3-chloro-1-methyl-but-3-enyl]-8-fluoro-quinoline-3-carboxamide, N-[(1S)-1-benzyl-3-chloro-1-methyl-but-3-enyl]-8-fluoro-quinoline-3-carboxamide, N-[(1R)-1-benzyl-3,3,3-trifluoro-1-methyl-propyl]-8-fluoro-quinoline-3-carboxamide, N-[(1S)-1-benzyl-3,3,3-trifluoro-1-methyl-propyl]-8-fluoro-quinoline-3-carboxamide, N-[(1R)-1-benzyl-1,3-dimethyl-butyl]-7,8-difluoro-quinoline-3-carboxamide, N-[(1S)-1-benzyl-1,3-dimethyl-butyl]-7,8-difluoro-quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluorophenyl)methyl]-1,3-dimethyl-butyl]quinoline-3-carboxamide, N-[(1R)-1-benzyl-1,3-dimethyl-butyl]-8-fluoro-quinoline-3-carboxamide, N-[(1S)-1-benzyl-1,3-dimethyl-butyl]-8-fluoro-quinoline-3-carboxamide, N-((1R)-1-benzyl-3-chloro-1-methyl-but-3-enyl)-8-fluoro-quinoline-3-carboxamide, N-((1S)-1-benzyl-3-chloro-1-methyl-but-3-enyl)-8-fluoro-quinoline-3-carboxamide (these compounds may be prepared from the methods described in WO2017/153380); 1-(6,7-dimethylpyrazolo[1,5-a]pyridin-3-yl)-4,4,5-trifluoro-3,3-dimethyl-isoquinoline, 1-(6,7-dimethylpyrazolo[1,5-a]pyridin-3-yl)-4,4,6-trifluoro-3,3-dimethyl-isoquinoline, 4,4-difluoro-3,3-dimethyl-1-(6-methylpyrazolo[1,5-a]pyridin-3-yl)isoquinoline, 4,4-difluoro-3,3-dimethyl-1-(7-methylpyrazolo[1,5-a]pyridin-3-yl)isoquinoline, 1-(6-chloro-7-methyl-pyrazolo[1,5-a]pyridin-3-yl)-4,4-difluoro-3,3-dimethyl-isoquinoline (these compounds may be prepared from the methods described in WO2017/025510); 1-(4,5-dimethylbenzimidazol-1-yl)-4,4,5-trifluoro-3,3-dimethyl-isoquinoline, 1-(4,5-dimethylbenzimidazol-1-yl)-4,4-difluoro-3,3-dimethyl-isoquinoline, 6-chloro-4,4-difluoro-3,3-dimethyl-1-(4-methylbenzimidazol-1-yl)isoquinoline, 4,4-difluoro-1-(5-fluoro-4-methyl-benzimidazol-1-yl)-3,3-dimethyl-isoquinoline, 3-(4,4-difluoro-3,3-dimethyl-1-isoquinolyl)-7,8-dihydro-6H-cyclopenta[e]benzimidazole (these compounds may be prepared from the methods described in WO2016/156085); N-methoxy-N-[[4-[5-(trifluoromethyl)-1,2,4-oxadiazol-3-yl]phenyl]methyl]cyclopropanecarboxamide, N,2-dimethoxy-N-[[4-[5-(trifluoromethyl)-1,2,4-oxadiazol-3-yl]phenyl]methyl]propanamide, N-ethyl-2-methyl-N-[[4-[5-(trifluoromethyl)-1,2,4-oxadiazol-3-yl]phenyl]methyl]propanamide, 1-methoxy-3-methyl-1-[[4-[5-(trifluoromethyl)-1,2,4-oxadiazol-3-yl]phenyl]methyl]urea, 1,3-dimethoxy-1-[[4-[5-(trifluoromethyl)-1,2,4-oxadiazol-3-yl]phenyl]methyl]urea, 3-ethyl-1-methoxy-1-[[4-[5-(trifluoromethyl)-1,2,4-oxadiazol-3-yl]phenyl]methyl]urea, N-[[4-[5-(trifluoromethyl)-1,2,4-oxadiazol-3-yl]phenyl]methyl]propanamide, 4,4-dimethyl-2-[[4-[5-(trifluoromethyl)-1,2,4-oxadiazol-3-yl]phenyl]methyl]isoxazolidin-3-one, 5,5-dimethyl-2-[[4-[5-(trifluoromethyl)-1,2,4-oxadiazol-3-yl]phenyl]methyl]isoxazolidin-3-one, ethyl 1-[[4-[5-(trifluoromethyl)-1,2,4-oxadiazol-3-yl]phenyl]methyl]pyrazole-4-carboxylate, N,N-dimethyl-1-[[4-[5-(trifluoromethyl)-1,2,4-oxadiazol-3-yl]phenyl]methyl]-1,2,4-triazol-3-amine (these compounds may be prepared from the methods described in WO 2017/055473, WO 2017/055469, WO 2017/093348 and WO 2017/118689); 2-[6-(4-chlorophenoxy)-2-(trifluoromethyl)-3-pyridyl]-1-(1,2,4-triazol-1-yl)propan-2-ol (this compound may be prepared from the methods described in WO 2017/029179); 2-[6-(4-bromophenoxy)-2-(trifluoromethyl)-3-pyridyl]-1-(1,2,4-triazol-1-yl)propan-2-ol (this compound may be prepared from the methods described in WO 2017/029179); 3-[2-(1-chlorocyclopropyl)-3-(2-fluorophenyl)-2-hydroxy-propyl]imidazole-4-carbonitrile (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile (this compound may be prepared from the methods described in WO 2016/156290); (4-phenoxyphenyl)methyl 2-amino-6-methyl-pyridine-3-carboxylate (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone (this compound may be prepared from the methods described in WO 2011/138281) N-methyl-4-[5-(trifluoromethyl)-1,2,4-oxadiazol-3-yl]benzenecarbothioamide; N-methyl-4-[5-(trifluoromethyl)-1,2,4-oxadiazol-3-yl]benzamide; (Z,2E)-5-[1-(2,4-dichlorophenyl)pyrazol-3-yl]oxy-2-methoxyimino-N,3-dimethyl-pent-3-enamide (this compound may be prepared from the methods described in WO 2018/153707); N′-(2-chloro-5-methyl-4-phenoxy-phenyl)-N-ethyl-N-methyl-formamidine; N′-[2-chloro-4-(2-fluorophenoxy)-5-methyl-phenyl]-N-ethyl-N-methyl-formamidine (this compound may be prepared from the methods described in WO 2016/202742); 2-(difluoromethyl)-N-[(3S)-3-ethyl-1,1-dimethyl-indan-4-yl]pyridine-3-carboxamide (this compound may be prepared from the methods described in WO 2014/095675); (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone (these compounds may be prepared from the methods described in WO 2017/220485); 2-oxo-N-propyl-2-[4-[5-(trifluoromethyl)-1,2,4-oxadiazol-3-yl]phenyl]acetamide (this compound may be prepared from the methods described in WO 2018/065414); ethyl 1-[[5-[5-(trifluoromethyl)-1,2,4-oxadiazol-3-yl]-2-thienyl]methyl]pyrazole-4-carboxylate (this compound may be prepared from the methods described in WO 2018/158365); 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N—[(Z)-methoxyiminomethyl]-4-[5-(trifluoromethyl)-1,2,4-oxadiazol-3-yl]benzamide, N—[N-methoxy-C-methyl-carbonimidoyl]-4-[5-(trifluoromethyl)-1,2,4-oxadiazol-3-yl]benzamide (these compounds may be prepared from the methods described in WO 2018/202428);
microbials including: Acinetobacter lwoffii, Acremonium alternatum, Acremonium cephalosporium, Acremonium diospyri, Acremonium obclavatum, Adoxophyes orana granulovirus (AdoxGV) (Capex®), Agrobacterium radiobacter strain K84 (Galltrol-A®), Alternaria alternate, Alternaria cassia, Alternaria destruens (Smolder®), Ampelomyces quisqualis (AQ10*), Aspergillus flavus AF36 (AF36*), Aspergillus flavus NRRL 21882 (Aflaguard®), Aspergillus spp., Aureobasidium pullulans, Azospirillum, (MicroAZ®, TAZO B®), Azotobacter, Azotobacter chroocuccum (Azotomeal®), Azotobacter cysts (Bionatural Blooming Blossoms®), Bacillus amyloliquefaciens, Bacillus cereus, Bacillus chitinosporus strain CM-1, Bacillus chitinosporus strain AQ746, Bacillus licheniformis strain HB-2 (Biostart™ Rhizoboost®), Bacillus licheniformis strain 3086 (EcoGuard®, Green Releaf®), Bacillus circulans, Bacillus firmus (BioSafe®, BioNem-WP®, VOTiVO®), Bacillus firmus strain 1-1582, Bacillus macerans, Bacillus marismortui, Bacillus megaterium, Bacillus mycoides strain AQ726, Bacillus papillae (Milky Spore Powder®), Bacillus pumilus spp., Bacillus pumilus strain GB34 (Yield Shield®), Bacillus pumilus strain AQ717, Bacillus pumilus strain QST 2808 (Sonata®, Ballad Plus®), Bacillus sphaericus (VectoLex®), Bacillus spp., Bacillus spp. strain AQ175, Bacillus spp. strain AQ177, Bacillus spp. strain AQ178, Bacillus subtilis strain QST 713 (CEASE®, Serenade®, Rhapsody®), Bacillus subtilis strain QST 714 (JAZZ®), Bacillus subtilis strain AQ153, Bacillus subtilis strain AQ743, Bacillus subtilis strain QST3002, Bacillus subtilis strain QST3004, Bacillus subtilis var. amyloliquefaciens strain FZB24 (Taegro®, Rhizopro®), Bacillus thuringiensis Cry 2Ae, Bacillus thuringiensis Cry1Ab, Bacillus thuringiensis aizawai GC 91 (Agree®), Bacillus thuringiensis israelensis (BMP123®, Aquabac®, VectoBac®), Bacillus thuringiensis kurstaki (Javelin®, Deliver®, CryMax®, Bonide®, Scutella WP®, Turilav WP®, Astuto®, Dipel WP®, Biobit®, Foray®), Bacillus thuringiensis kurstaki BMP 123 (Baritone®), Bacillus thuringiensis kurstaki HD-1 (Bioprotec-CAF/3P©), Bacillus thuringiensis strain BD #32, Bacillus thuringiensis strain AQ52, Bacillus thuringiensis var. aizawai (XenTari®, DiPel®), bacteria spp. (GROWMEND®, GROWSWEET®, Shootup®), bacteriophage of Clavipacter michiganensis (AgriPhage®), Bakflor®, Beauveria bassiana (Beaugenic®, Brocaril WP®), Beauveria bassiana GHA (Mycotrol ES®, Mycotrol O®, BotaniGuard®), Beauveria brongniartii (Engerlingspilz®, Schweizer Beauveria®, Melocont®), Beauveria spp., Botrytis cineria, Bradyrhizobium japonicum (TerraMax®), Brevibacillus brevis, Bacillus thuringiensis tenebrionis (Novodor®), BtBooster, Burkholderia cepacia (Deny®, Intercept®, Blue Circle®), Burkholderia gladii, Burkholderia gladioli, Burkholderia spp., Canadian thistle fungus (CBH Canadian Bioherbicide®), Candida butyri, Candida famata, Candida fructus, Candida glabrata, Candida guilliermondii, Candida melibiosica, Candida oleophila strain O, Candida parapsilosis, Candida pelliculosa, Candida pulcherrima, Candida reukaufii, Candida saitoana (Bio-Coat®, Biocure®), Candida sake, Candida spp., Candida tenius, Cedecea dravisae, Cellulomonas flavigena, Chaetomium cochliodes (Nova-Cide®), Chaetomium globosum (Nova-Cide®), Chromobacterium subtsugae strain PRAA4-1T (Grandevo®), Cladosporium cladosporioides, Cladosporium oxysporum, Cladosporium chlorocephalum, Cladosporium spp., Cladosporium tenuissimum, Clonostachys rosea (EndoFine®), Colletotrichum acutatum, Coniothyrium minitans (Cotans WG®), Coniothyrium spp., Cryptococcus albidus (YIELDPLUS®), Cryptococcus humicola, Cryptococcus infirmo-miniatus, Cryptococcus laurentii, Cryptophlebia leucotreta granulovirus (Cryptex®), Cupriavidus campinensis, Cydia pomonella granulovirus (CYD-X®), Cydia pomonella granulovirus (Madex®, Madex Plus®, Madex Max/Carpovirusine®), Cylindrobasidium laeve (Stumpout®), Cylindrocladium, Debaryomyces hansenii, Drechslera hawaiinensis, Enterobacter cloacae, Enterobacteriaceae, Entomophtora virulenta (Vektor®), Epicoccum nigrum, Epicoccum purpurascens, Epicoccum spp., Filobasidium floriforme, Fusarium acuminatum, Fusarium chlamydosporum, Fusarium oxysporum (Fusaclean®/Biofox C®), Fusarium proliferatum, Fusarium spp., Galactomyces geotrichum, Gliocladium catenulatum (Primastop®, Prestop®), Gliocladium roseum, Gliocladium spp. (SoilGard®), Gliocladium virens (Soilgard®), Granulovirus (Granupom®), Halobacillus halophilus, Halobacillus litoralis, Halobacillus trueperi, Halomonas spp., Halomonas subglaciescola, Halovibrio variabilis, Hanseniaspora uvarum, Helicoverpa armigera nucleopolyhedrovirus (Helicovex®), Helicoverpa zea nuclear polyhedrosis virus (Gemstar®), Isoflavone-formononetin (Myconate®), Kloeckera apiculata, Kloeckera spp., Lagenidium giganteum (Laginex®), Lecanicillium longisporum (Vertiblast®), Lecanicillium muscarium (Vertikil®), Lymantria Dispar nucleopolyhedrosis virus (Disparvirus®), Marinococcus halophilus, Meira geulakonigii, Metarhizium anisopliae (Met52®), Metarhizium anisopliae (Destruxin WP®), Metschnikowia fruticola (Shemer®), Metschnikowia pulcherrima, Microdochium dimerum (Antibot®), Micromonospora coerulea, Microsphaeropsis ochracea, Muscodor albus 620 (Muscudor®), Muscodor roseus strain A3-5, Mycorrhizae spp. (AMykor®, Root Maximizer®), Myrothecium verrucaria strain AARC-0255 (DiTera®), BROS PLUS®, Ophiostoma piliferum strain D97 (Sylvanex®), Paecilomyces farinosus, Paecilomyces fumosoroseus (PFR-97®, PreFeRal®), Paecilomyces linacinus (Biostat WP®), Paecilomyces lilacinus strain 251 (MeloCon WG®), Paenibacillus polymyxa, Pantoea agglomerans (BlightBan C9-1*), Pantoea spp., Pasteuria spp. (Econem®), Pasteuria nishizawae, Penicillium aurantiogriseum, Penicillium billai (Jumpstart®, TagTeam®), Penicillium brevicompactum, Penicillium frequentans, Penicillium griseofulvum, Penicillium purpurogenum, Penicillium spp., Penicillium viridicatum, Phlebiopsis gigantean (Rotstop®), phosphate solubilizing bacteria (Phosphomeal®), Phytophthora cryptogea, Phytophthora palmivora (Devine®), Pichia anomala, Pichia guilermondii, Pichia membranaefaciens, Pichia onychis, Pichia stipites, Pseudomonas aeruginosa, Pseudomonas aureofasciens (Spot-Less Biofungicide®), Pseudomonas cepacia, Pseudomonas chlororaphis (AtEze®), Pseudomonas corrugate, Pseudomonas fluorescens strain A506 (BlightBan A506*), Pseudomonas putida, Pseudomonas reactans, Pseudomonas spp., Pseudomonas syringae (Bio-Save®), Pseudomonas viridiflava, Pseudomons fluorescens (Zequanox®), Pseudozyma flocculosa strain PF-A22 UL (Sporodex L®), Puccinia canaliculata, Puccinia thlaspeos (Wood Warrior®), Pythium paroecandrum, Pythium oligandrum (Polygandron®, Polyversum®), Pythium periplocum, Rhanella aquatilis, Rhanella spp., Rhizobia (Dormal®, Vault®), Rhizoctonia, Rhodococcus globerulus strain AQ719, Rhodosporidium diobovatum, Rhodosporidium toruloides, Rhodotorula spp., Rhodotorula glutinis, Rhodotorula graminis, Rhodotorula mucilagnosa, Rhodotorula rubra, Saccharomyces cerevisiae, Salinococcus roseus, Sclerotinia minor, Sclerotinia minor (SARRITOR®), Scytalidium spp., Scytalidium uredinicola, Spodoptera exigua nuclear polyhedrosis virus (Spod-X®, Spexit®), Serratia marcescens, Serratia plymuthica, Serratia spp., Sordaria fimicola, Spodoptera littoralis nucleopolyhedrovirus (Littovir®), Sporobolomyces roseus, Stenotrophomonas maltophilia, Streptomyces ahygroscopicus, Streptomyces albaduncus, Streptomyces exfoliates, Streptomyces galbus, Streptomyces griseoplanus, Streptomyces griseoviridis (Mycostop®), Streptomyces lydicus (Actinovate®), Streptomyces lydicus WYEC-108 (ActinoGrow®), Streptomyces violaceus, Tilletiopsis minor, Tilletiopsis spp., Trichoderma asperellum (T34 Biocontrol®), Trichoderma gamsii (Tenet®), Trichoderma atroviride (Plantmate®), Trichoderma hamatum TH 382, Trichoderma harzianum rifai (Mycostar®), Trichoderma harzianum T-22 (Trianum-P®, PlantShield HC®, RootShield®, Trianum-G®), Trichoderma harzianum T-39 (Trichodex®), Trichoderma inhamatum, Trichoderma koningii, Trichoderma spp. LC 52 (Sentinel®), Trichoderma lignorum, Trichoderma longibrachiatum, Trichoderma polysporum (Binab T®), Trichoderma taxi, Trichoderma virens, Trichoderma virens (formerly Gliocladium virens GL-21) (SoilGuard®), Trichoderma viride, Trichoderma viride strain ICC 080 (Remedier®), Trichosporon pullulans, Trichosporon spp., Trichothecium spp., Trichothecium roseum, Typhula phacorrhiza strain 94670, Typhula phacorrhiza strain 94671, Ulocladium atrum, Ulocladium oudemansii (Botry-Zen®), Ustilago maydis, various bacteria and supplementary micronutrients (Natural II®), various fungi (Millennium Microbes®), Verticillium chlamydosporium, Verticillium lecanii (Mycotal®, Vertalec®), Vip3Aa20 (VIPtera®), Virgibaclillus marismortui, Xanthomonas campestris pv. Poae (Camperico®), Xenorhabdus bovienii, Xenorhabdus nematophilus;
Plant extracts including: pine oil (Retenol®), azadirachtin (Plasma Neem Oil®, AzaGuard®, MeemAzal®, Molt-X®, Botanical IGR (Neemazad®, Neemix®), canola oil (Lilly Miller Vegol®), Chenopodium ambrosioides near ambrosioides (Requiem®), Chrysanthemum extract (Crisant®), extract of neem oil (Trilogy®), essentials oils of Labiatae (Botania®), extracts of clove rosemary peppermint and thyme oil (Garden insect Killer®), Glycinebetaine (Greenstim®), garlic, lemongrass oil (GreenMatch®), neem oil, Nepeta cataria (Catnip oil), Nepeta catarina, nicotine, oregano oil (MossBuster®), Pedaliaceae oil (Nematon®), pyrethrum, Quillaja saponaria (NemaQ®), Reynoutria sachalinensis (Regalia®, Sakalia®), rotenone (Eco Roten®), Rutaceae plant extract (Soleo®), soybean oil (Ortho Ecosense®), tea tree oil (Timorex Gold®), thymus oil, AGNIQUE® MMF, BugOil®, mixture of rosemary sesame pepermint thyme and cinnamon extracts (EF 300®), mixture of clove rosemary and peppermint extract (EF 400®), mixture of clove pepermint garlic oil and mint (Soil Shot®), kaolin (Screen®), storage glucam of brown algae (Laminarin®);
pheromones including: blackheaded fireworm pheromone (3M Sprayable Blackheaded Fireworm Pheromone®), Codling Moth Pheromone (Paramount dispenser-(CM)/Isomate C-Plus®), Grape Berry Moth Pheromone (3M MEC-GBM Sprayable Pheromone®), Leafroller pheromone (3M MEC—LR Sprayable Pheromone®), Muscamone (Snip7 Fly Bait®, Starbar Premium Fly Bait®), Oriental Fruit Moth Pheromone (3M oriental fruit moth sprayable Pheromone®), Peachtree Borer Pheromone (Isomate-P®), Tomato Pinworm Pheromone (3M Sprayable Pheromone®), Entostat powder (extract from palm tree) (Exosex CM®), (E,Z,Z)-3,8,11 Tetradecatrienyl acetate, (Z,Z,E)-7,11,13-Hexadecatrienal, (E,Z)-7,9-Dodecadien-1-yl acetate, 2-Methyl-1-butanol, Calcium acetate, Scenturion®, Biolure®, Check-Mate®, Lavandulyl senecioate;
Macrobials including: Aphelinus abdominalis, Aphidius ervi (Aphelinus-System®), Acerophagus papaya, Adalia bipunctata (Adalia-System®), Adalia bipunctata (Adaline®), Adalia bipunctata (Aphidalia®), Ageniaspis citricola, Ageniaspis fuscicollis, Amblyseius andersoni (Anderline®, Andersoni-System®), Amblyseius californicus (Amblyline®, Spical®), Amblyseius cucumeris (Thripex®, Bugline Cucumeris®), Amblyseius fallacis (Fallacis®), Amblyseius swirskii (Bugline Swirskii®, Swirskii-Mite®), Amblyseius womersleyi (WomerMite®), Amitus hesperidum, Anagrus atomus, Anagyrus fusciventris, Anagyrus kamali, Anagyrus loecki, Anagyrus pseudococci (Citripar®), Anicetus benefices, Anisopteromalus calandrae, Anthocoris nemoralis (Anthocoris-System®), Aphelinus abdominalis (Apheline®, Aphiline®), Aphelinus asychis, Aphidius colemani (Aphipar®), Aphidius ervi (Ervipar®), Aphidius gifuensis, Aphidius matricariae (Aphipar-M®), Aphidoletes aphidimyza (Aphidend®), Aphidoletes aphidimyza (Aphidoline®), Aphytis lingnanensis, Aphytis melinus, Aprostocetus hagenowii, Atheta coriaria (Staphyline®), Bombus spp., Bombus terrestris (Natupol Beehive®), Bombus terrestris (Beeline®, Tripol®), Cephalonomia stephanoderis, Chilocorus nigritus, Chrysoperla carnea (Chrysoline®), Chrysoperla carnea (Chrysopa®), Chrysoperla rufilabris, Cirrospilus ingenuus, Cirrospilus quadristriatus, Citrostichus phyllocnistoides, Closterocerus chamaeleon, Closterocerus spp., Coccidoxenoides perminutus (Planopar®), Coccophagus cowperi, Coccophagus lycimnia, Cotesia flavipes, Cotesia plutellae, Cryptolaemus montrouzieri (Cryptobug®, Cryptoline®), Cybocephalus nipponicus, Dacnusa sibirica, Dacnusa sibirica (Minusa®), Diglyphus isaea (Diminex®), Delphastus catalinae (Delphastus®), Delphastus pusillus, Diachasmimorpha krausii, Diachasmimorpha longicaudata, Diaparsis jucunda, Diaphorencyrtus aligarhensis, Diglyphus isaea, Diglyphus isaea (Miglyphus®, Digline®), Dacnusa sibirica (DacDigline®, Minex®), Diversinervus spp., Encarsia citrina, Encarsia formosa (Encarsia Max®, Encarline®, En-Strip®), Eretmocerus eremicus (Enermix®), Encarsia guadeloupae, Encarsia haitiensis, Episyrphus balteatus (Syrphidend®), Eretmoceris siphonini, Eretmocerus californicus, Eretmocerus eremicus (Ercal®, Eretline E®), Eretmocerus eremicus (Bemimix®), Eretmocerus hayati, Eretmocerus mundus (Bemipar®, Eretline M®), Eretmocerus siphonini, Exochomus quadripustulatus, Feltiella acarisuga (Spidend®), Feltiella acarisuga (Feltiline®), Fopius arisanus, Fopius ceratitivorus, Formononetin (Wirless Beehome®), Franklinothrips vespiformis (Vespop®), Galendromus occidentalis, Goniozus legneri, Habrobracon hebetor, Harmonia axyridis (HarmoBeetle®), Heterorhabditis spp. (Lawn Patrol®), Heterorhabditis bacteriophora (NemaShield HB®, Nemaseek®, Terranem-Nam®, Terranem®, Larvanem®, B-Green®, NemAttack®, Nematop®), Heterorhabditis megidis (Nemasys H®, BioNem H®, Exhibitline Hm®, Larvanem-M®), Hippodamia convergens, Hypoaspis aculeifer (Aculeifer-System®, Entomite-A®), Hypoaspis miles (Hypoline M®, Entomite-M®), Lbalia leucospoides, Lecanoideus floccissimus, Lemophagus errabundus, Leptomastidea abnormis, Leptomastix dactylopii (Leptopar®), Leptomastix epona, Lindorus lophanthae, Lipolexis oregmae, Lucilia caesar (Natufly®), Lysiphlebus testaceipes, Macrolophus caliginosus (Mirical-N®, Macroline C®, Mirical®), Mesoseiulus longipes, Metaphycus flavus, Metaphycus lounsburyi, Micromus angulatus (Milacewing®), Microterys flavus, Muscidifurax raptorellus and Spalangia cameroni (Biopar®), Neodryinus typhlocybae, Neoseiulus californicus, Neoseiulus cucumeris (THRYPEX®), Neoseiulus fallacis, Nesideocoris tenuis (NesidioBug®, Nesibug®), Ophyra aenescens (Biofly®), Orius insidiosus (Thripor-I®, Oriline I®), Orius laevigatus (Thripor-L®, Oriline I®), Orius majusculus (Oriline M®), Orius strigicollis (Thripor-S®), Pauesia juniperorum, Pediobius foveolatus, Phasmarhabditis hermaphrodita (Nemaslug®), Phymastichus coffea, Phytoseiulus macropilus, Phytoseiulus persimilis (Spidex®, Phytoline P®), Podisus maculiventris (Podisus®), Pseudacteon curvatus, Pseudacteon obtusus, Pseudacteon tricuspis, Pseudaphycus maculipennis, Pseudleptomastix mexicana, Psyllaephagus pilosus, Psyttalia concolor (complex), Quadrastichus spp., Rhyzobius lophanthae, Rodolia cardinalis, Rumina decollate, Semielacher petiolatus, Sitobion avenae (Ervibank®), Steinernema carpocapsae (Nematac C®, Millenium®, BioNem C®, NemAttack®, Nemastar®, Capsanem®), Steinernema feltiae (NemaShield®, Nemasys F®, BioNem F®, Steinernema-System®, NemAttack®, Nemaplus®, Exhibitline Sf®, Scia-Rid®, Entonem®), Steinernema kraussei (Nemasys L®, BioNem L®, Exhibitline Srb®), Steinernema riobrave (BioVector®, BioVektor®), Steinernema scapterisci (Nematac S®), Steinernema spp., Steinernematid spp. (Guardian Nematodes®), Stethorus punctillum (Stethorus®), Tamarixia radiate, Tetrastichus setifer, Thripobius semiluteus, Torymus sinensis, Trichogramma brassicae (Tricholine B®), Trichogramma brassicae (Tricho-Strip®), Trichogramma evanescens, Trichogramma minutum, Trichogramma ostriniae, Trichogramma platneri, Trichogramma pretiosum, Xanthopimpla stemmator;
other biologicals including: abscisic acid, bioSea®, Chondrostereum purpureum (Chontrol Paste®), Colletotrichum gloeosporioides (Collego®), Copper Octanoate (Cueva®), Delta traps (Trapline D®), Erwinia amylovora (Harpin) (ProAct®, Ni-HIBIT Gold CST®), fatty acids derived from a natural by-product of extra virgin olive oil (FLIPPER®), Ferri-phosphate (Ferramol®), Funnel traps (Trapline Y®), Gallex®, Grower's Secret®, Homo-brassonolide, Iron Phosphate (Lilly Miller Worry Free Ferramol Slug & Snail Bait®), MCP hail trap (Trapline F®), Microctonus hyperodae, Mycoleptodiscus terrestris (Des-X®), BioGain®, Aminomite®, Zenox®, Pheromone trap (Thripline Ams®), potassium bicarbonate (MilStop®), potassium salts of fatty acids (Sanova®), potassium silicate solution (Sil-Matrix®), potassium iodide+potassiumthiocyanate (Enzicur®), SuffOil-X®, Spider venom, Nosema locustae (Semaspore Organic Grasshopper Control®), Sticky traps (Trapline YF®, Rebell Amarillo®) and Traps (Takitrapline y+B®);
a safener, such as benoxacor, cloquintocet (including cloquintocet-mexyl), cyprosulfamide, dichlormid, fenchlorazole (including fenchlorazole-ethyl), fenclorim, fluxofenim, furilazole, isoxadifen (including isoxadifen-ethyl), mefenpyr (including mefenpyr-diethyl), metcamifen and oxabetrinil.

Suitable fungicides may be selected from etridiazole, fluazinam, benalaxyl, benalaxyl-M (kiralaxyl), furalaxyl, metalaxyl, metalaxyl-M (mefenoxam), dodicin, N′-(2,5-dimethyl-4-phenoxy-phenyl)-N-ethyl-N-methyl-formamidine, N′-[4-(4,5-dichloro-thiazol-2-yloxy)-2,5-dimethyl-phenyl]-N-ethyl-N-methyl-formamidine, N′-[4-[[3-[(4-chlorophenyl)methyl]-1,2,4-thiadiazol-5-yl]oxy]-2,5-dimethyl-phenyl]-N-ethyl-N-methyl-formamidine, ethirimol, 3′-chloro-2-methoxy-N-[(3RS)-tetrahydro-2-oxofuran-3-yl]acet-2′,6′-xylidide (clozylacon), cyprodinil, mepanipyrim, pyrimethanil, dithianon, aureofungin, blasticidin-S, biphenyl, chloroneb, dicloran, benzovindiflupyr, pydiflumetofen, hexachlorobenzene, quintozene, tecnazene, (TCNB), tolclofos-methyl, metrafenone, 2,6-dichloro-N-(4-trifluoromethylbenzyl)-benzamide, fluopicolide (flupicolide), tioxymid, flusulfamide, benomyl, carbendazim, carbendazim chlorhydrate, chlorfenazole, fuberidazole, thiabendazole, thiophanate-methyl, benthiavalicarb, chlobenthiazone, probenazole, acibenzolar, bethoxazin, pyriofenone (IKF-309), acibenzolar-S-methyl, pyribencarb (KIF-7767), butylamine, 3-iodo-2-propinyl n-butylcarbamate (IPBC), iodocarb (isopropanyl butylcarbamate), isopropanyl butylcarbamate (iodocarb), picarbutrazox, polycarbamate, propamocarb, tolprocarb, 3-(difluoromethyl)-N-(7-fluoro-1,1,3,3-tetramethyl-indan-4-yl)-1-methyl-pyrazole-4-carboxamide diclocymet, N-[(5-chloro-2-isopropyl-phenyl)methyl]-N-cyclopropyl-3-(difluoromethyl)-5-fluoro-1-methyl-pyrazole-4-carboxamide N-cyclopropyl-3-(difluoromethyl)-5-fluoro-N-[(2-isopropylphenyl)methyl]-1-methyl-pyrazole-4-carboxamide carpropamid, chlorothalonil, flumorph, oxine-copper, cymoxanil, phenamacril, cyazofamid, flutianil, thicyofen, chlozolinate, iprodione, procymidone, vinclozolin, bupirimate, dinocton, dinopenton, dinobuton, dinocap, meptyldinocap, diphenylamine, phosdiphen, 2,6-dimethyl-[1,4]dithiino[2,3-c:5,6-c′]dipyrrole-1,3,5,7(2H,6H)-tetraone, azithiram, etem, ferbam, mancozeb, maneb, metam, metiram (polyram), metiram-zinc, nabam, propineb, thiram, vapam (metam sodium), zineb, ziram, dithioether, isoprothiolane, ethaboxam, fosetyl, phosetyl-AI (fosetyl-al), methyl bromide, methyl iodide, methyl isothiocyanate, cyclafuramid, fenfuram, validamycin, streptomycin, (2RS)-2-bromo-2-(bromomethyl)glutaronitrile (bromothalonil), dodine, doguadine, guazatine, iminoctadine, iminoctadine triacetate, 2,4-D, 2,4-DB, kasugamycin, dimethirimol, fenhexamid, hymexazole, hydroxyisoxazole imazalil, imazalil sulphate, oxpoconazole, pefurazoate, prochloraz, triflumizole, fenamidone, Bordeaux mixture, calcium polysulfide, copper acetate, copper carbonate, copper hydroxide, copper naphthenate, copper oleate, copper oxychloride, copper oxyquinolate, copper silicate, copper sulphate, copper tallate, cuprous oxide, sulphur, carbaryl, phthalide (fthalide), dingjunezuo (Jun Si Qi), oxathiapiprolin, fluoroimide, mandipropamid, KSF-1002, benzamorf, dimethomorph, fenpropimorph, tridemorph, dodemorph, diethofencarb, fentin acetate, fentin hydroxide, carboxin, oxycarboxin, drazoxolon, famoxadone, m-phenylphenol, p-phenylphenol, tribromophenol (TBP), 2-[2-[(7,8-difluoro-2-methyl-3-quinolyl)oxy]-6-fluoro-phenyl]propan-2-ol 2-[2-fluoro-6-[(8-fluoro-2-methyl-3-quinolyl)oxy]phenyl]propan-2-ol cyflufenamid, ofurace, oxadixyl, flutolanil, mepronil, isofetamid, fenpiclonil, fludioxonil, pencycuron, edifenphos, iprobenfos, pyrazophos, phosphorus acids, tecloftalam, captafol, captan, ditalimfos, triforine, fenpropidin, piperalin, osthol, 1-methylcyclopropene, 4-CPA, chlormequat, clofencet, dichlorprop, dimethipin, endothal, ethephon, flumetralin, forchlorfenuron, gibberellic acid, gibberellins, hymexazol, maleic hydrazide, mepiquat, naphthalene acetamide, paclobutrazol, prohexadione, prohexadione-calcium, thidiazuron, tribufos (tributyl phosphorotrithioate), trinexapac, uniconazole, α-naphthalene acetic acid, polyoxin D (polyoxrim), BLAD, chitosan, fenoxanil, folpet, 3-(difluoromethyl)-N-methoxy-1-methyl-N-[1-methyl-2-(2,4,6-trichlorophenyl)ethyl]pyrazole-4-carboxamide, bixafen, fluxapyroxad, furametpyr, isopyrazam, penflufen, penthiopyrad, sedaxane, fenpyrazamine, diclomezine, pyrifenox, boscalid, fluopyram, diflumetorim, fenarimol, 5-fluoro-2-(p-tolylmethoxy)pyrimidin-4-amine ferimzone, dimetachlone (dimethaclone), pyroquilon, proquinazid, ethoxyquin, quinoxyfen, 4,4,5-trifluoro-3,3-dimethyl-1-(3-quinolyl)isoquinoline, 4,4-difluoro-3,3-dimethyl-1-(3-quinolyl)isoquinoline 5-fluoro-3,3,4,4-tetramethyl-1-(3-quinolyl)isoquinoline 9-fluoro-2,2-dimethyl-5-(3-quinolyl)-3H-1,4-benzoxazepine, tebufloquin, oxolinic acid, chinomethionate (oxythioquinox, quinoxymethionate), spiroxamine, (E)-N-methyl-2-[2-(2, 5-dimethylphenoxymethyl) phenyl]-2-methoxy-iminoacetamide, (mandestrobin), azoxystrobin, coumoxystrobin, dimoxystrobin, enestroburin, enoxastrobin, fenamistrobin, flufenoxystrobin, fluoxastrobin, kresoxim-methyl, mandestrobin, metaminostrobin, metominostrobin, orysastrobin, picoxystrobin, pyraclostrobin, pyrametostrobin, pyraoxystrobin, triclopyricarb, trifloxystrobin, amisulbrom, dichlofluanid, tolylfluanid, but-3-ynyl N-[6-[[(Z)-[(1-methyltetrazol-5-yl)-phenyl-methylene]amino]oxymethyl]-2-pyridyl]carbamate, dazomet, isotianil, tiadinil, thifluzamide, benthiazole (TCMTB), silthiofam, zoxamide, anilazine, tricyclazole, (.+-.)-cis-1-(4-chlorophenyl)-2-(1H-1,2,4-triazol-1-yl)-cycloheptanol (huanjunzuo), 1-(5-bromo-2-pyridyl)-2-(2,4-difluorophenyl)-1,1-difluoro-3-(1,2,4-triazol-1-yl)propan-2-ol 2-(1-tert-butyl)-1-(2-chlorophenyl)-3-(1,2,4-triazol-1-yl)-propan-2-ol (TCDP), azaconazole, bitertanol (biloxazol), bromuconazole, climbazole, cyproconazole, difenoconazole, dimetconazole, diniconazole, diniconazole-M, epoxiconazole, etaconazole, fenbuconazole, fluquinconazole, flusilazole, flutriafol, hexaconazole, imibenconazole, ipconazole, ipfentrifluconazole, metconazole, myclobutanil, penconazole, propiconazole, prothioconazole, simeconazole, tebuconazole, tetraconazole, triadimefon, triadimenol, triazoxide, triticonazole, mefentrifluconazole, 2-[[(1R,5S)-5-[(4-fluorophenyl)methyl]-1-hydroxy-2,2-dimethyl-cyclopentyl]methyl]-4H-1,2,4-triazole-3-thione, 2-[[3-(2-chlorophenyl)-2-(2,4-difluorophenyl)oxiran-2-yl]methyl]-4H-1,2,4-triazole-3-thione, ametoctradin (imidium), iprovalicarb, valifenalate, 2-benzyl-4-chlorophenol (Chlorophene), allyl alcohol, azafenidin, benzalkonium chloride, chloropicrin, cresol, daracide, dichlorophen (dichlorophene), difenzoquat, dipyrithione, N-(2-p-chlorobenzoylethyl)-hexaminium chloride, NNF-0721, octhilinone, oxasulfuron, propamidine and propionic acid.

The agrochemical may be in mesomeric forms, as well as stereoisomers or enantiomers and, where applicable, various polymorphic modifications.

More preferably, suitable herbicides include pinoxaden, bicyclopyrone, mesotrione, fomesafen, tralkoxydim, napropamide, amitraz, propanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluazifop, S-metolachlor, glyphosate, glufosinate, paraquat, diquat, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, iodosulfuron, mesosulfuron, diflufenican, flufenacet, fluroxypyr, aminopyralid, pyroxsulam, XDE-848 Rinskor and halauxifen-methyl.

Suitable fungicides include isopyrazam, mandipropamid, azoxystrobin, trifloxystrobin, kresoxim methyl, mefenoxam, famoxadone, metominostrobin, picoxystrobin, cyprodanil, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, adepidyn, bixafen, fluxapyroxad, prothioconazole, pyraclostrobin, revysol, solatenol and xemium.

Suitable insecticides include thiamethoxam, imidacloprid, acetamiprid, clothianidin, dinotefuran, nitenpyram, fipronil, abamectin, emamectin, tefluthrin, emamectin benzoate, bendiocarb, carbaryl, fenoxycarb, isoprocarb, pirimicarb, propoxur, xylylcarb, asulam, chlorpropham, endosulfan, heptachlor, tebufenozide, bensultap, diethofencarb, pirimiphos methyl, aldicarb, methomyl, cyprmethrin, bioallethrin, deltamethrin, lambda cyhalothrin, cyhalothrin, cyfluthrin, fenvalerate, imiprothrin, permethrin, halfenprox, oxamyl, flupyradifurone, sedaxane, inscalis, rynaxypyr, cyantraniliprole, sulfoxaflor and spinetoram.

Suitable plant growth regulators include paclobutrazole, trinexapac-ethyl and 1 methylcyclopropene. Suitable safeners include benoxacor, cloquintocet-mexyl, cyometrinil, dichlormid, fenchlorazole-ethyl, fenclorim, flurazole, fluxofenim, mefenpyr-diethyl, MG-191, naphthalic anhydride and oxabetrinil.

Suitably, the agrochemical is selected from bicyclopyrone, mesotrione, pinoxaden, fomesafen, tralkoxydim, napropamide, amitraz, propanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, isopyrazam, mandipropamid, azoxystrobin, trifloxystrobin, kresoxim methyl, famoxadone, metominostrobin and picoxystrobin, cyprodanil, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, thiamethoxam, imidacloprid, acetamiprid, clothianidin, dinotefuran, nitenpyram, fipronil, abamectin, emamectin, bendiocarb, carbaryl, fenoxycarb, isoprocarb, pirimicarb, propoxur, xylylcarb, asulam, chlorpropham, endosulfan, heptachlor, tebufenozide, bensultap, diethofencarb, pirimiphos methyl, aldicarb, methomyl, cyprmethrin, bioallethrin, deltamethrin, lambda cyhalothrin, cyhalothrin, cyfluthrin, fenvalerate, imiprothrin, permethrin, halfenprox, paclobutrazole, 1-methylcyclopropene, benoxacor, cloquintocet-mexyl, cyometrinil, dichlormid, fenchlorazole-ethyl, fenclorim, flurazole, fluxofenim, mefenpyr-diethyl, MG-191, naphthalic anhydride and oxabetrinil. Preferred agrochemical active ingredients are selected from fomesafen (suitably as the sodium salt), mesotrione, nicosulfuron, pinoxaden, isopyrazam, epoxiconazole, solatenol and cyantraniliprole.

Advantageously the composition comprises one or more surfactants and/or oils (such as mineral oils and/or vegetable oils).

Surfactants are employed as formulation components and as adjuvants and may be present in an amount of from 0.00001 to 8% by weight, such as from 0.0001 to 5% by weight, from 0.001 to 4% by weight, from 0.01 to 3% by weight, or even 0.1 to 2% by weight.

Suitable ionic surfactants are the alkali, alkaline earth and ammonium salts of aromatic sulphonic acids, for example of lignosulphonic acid, phenolsulphonic acid, naphthalenesulphonic acid, dibutylnaphthalenesulphonic acid or of fatty acids, alkyl- and alkylarylsulfonates, alkylsulphates, lauryl ether sulphates and fatty alcohol sulphates, and salts of sulphated hexa-, hepta- and octa-decanols, and of fatty alcohol glycol ethers, condensates of sulfonated naphthalene and its derivatives with formaldehyde, condensates of naphthalene or of the naphthalenesulphonic acids with phenol and formaldehyde, polycarboxylates or phosphate esters of alkoxylated alcohols.

Suitable nonionic surfactants are polyoxyethylene octyl phenol ethers, alkoxylated alcohols such as ethoxylated isooctyl-, octyl- or nonyl-phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, alkyl polyglycosides, polyoxyethylene alkyl ethers or polyoxypropylene alkyl ethers, lauryl alcohol polyglycol ether acetate, sorbitol esters, lignin-sulfite waste liquors and also proteins, denatured proteins, hydrophobically modified starches, polyvinyl alcohols (for example Mowiol®), polyalkoxylates, polyvinylamines, polyethyleneimines, polyvinylpyrrolidones and their copolymers or block polymers.

Organic liquids (oils) can be employed as components of formulations as solvents or adjuvants. They can also be added to a spray tank dilution as an adjuvant to perform a variety of functions such as, but not exclusively, uptake improvement, spreading, rainfastness enhancement, drift reduction, volatility reduction.

Suitable oils can be oils of vegetable, mineral and animal origin and alkyl esters of these oils such as vegetable oils and vegetable oil esters and diesters (including esters with glycerine and propylene glycol). Some preferred oils are methyl, ethyl, isopropyl, isobutyl, butyl, hexyl and ethyl hexyl esters. Others are the vegetable oils and esters selected from the group consisting of methyl oleate, ethyl oleate, methyl palmitate, rape seed oil methyl ester, isopropyl myristate, isopropyl palmitate, ethylhexyl palmitate, ethylhexyl oleate, mixtures of ethylhexyl myristate/laurate, ethylhexyl laurate, mixtures of ethylhexyl caprylate/caprate, diisopropyl adipate, coconut oil propylene glycol diester, sunflower oil, rapeseed oil, corn oil, soybean oil and its alkyl esters, rice bran oil and its alkyl esters, olive oil, peanut oil mixed caprylic and capnc triglycerides, and mixed decanoyl and octanoyl glycerides. Also suitable are the mineral oils such as Exxsol D100, Solvesso 200ND, and white oil and the alkyl esters of phosphoric and phosphonic acids such as tris-alkyl-phosphate esters. preferably tris (2-ethylhexyl) phosphate.

Preferably the one or more surfactants and/or oils are selected from non-ionic and ionic surfactants, castor oil ethoxylates, sulphosuccinic esters, alkyl polyglycosides, polypropylene glycol-polyethylene glycol copolymers and/or ethoxylated trisiloxanes.

The composition may contain an additional polymer, preferably wherein the polymer selected is a polysaccharide. Advantageously the additional polymer is selected from one or more of native and modified guar gums, xanthan gum, natural and/or modified cellulosic.

The compositions as described herein are advantageously suitable for use in a precision application device. There is also provided the use of a composition as described herein in a precision application device.

In a second aspect of the invention there is provided an precision application device and a composition comprising:
an agrochemical;
a polymer; and
a carrier fluid;
wherein the polymer is selected from one or more polysaccharides.

The device comprises a nozzle, preferably a jetting nozzle or small angle flat fan nozzle. Such a device advantageously dosing deposits at an application rate of 20 to 3000 L/Ha, preferably 200 to 500 L/Ha.

Advantageously the composition comprises one or more surfactants and/or oils (such as mineral oils and/or vegetable oils).

The polymer is preferably selected from one or more of diutan gum, native and modified guar gums, xanthan gum, natural and/or modified cellulosic. Advantageously, the polymer may be present in an amount of from 0.001 to 2% by weight, preferably from 0.01 to 0.20% by weight Preferably the carrier fluid comprises water, such as from 80 to 100% or from 80 to 99.5% by weight of the carrier fluid.

Advantageously the agrochemical is used at the maximum usage rate per the label of the active ingredient. The agrochemical may be used in an amount of from 0.0001 to 25% by weight, such from 0.001 to 20% by weight, from 0.01 to 5% by weight, or from 6 to 15% by weight. The agrochemical is preferably selected from the list defined above.

Surfactants are employed as formulation components and as adjuvants and may be present in an amount of from 0.00001 to 8% by weight, such as from 0.0001 to 5% by weight, from 0.001 to 4% by weight, from 0.01 to 3% by weight, or even 0.1 to 2% by weight.

Suitable ionic surfactants are the alkali, alkaline earth and ammonium salts of aromatic sulphonic acids, for example of lignosulphonic acid, phenolsulphonic acid, naphthalenesulphonic acid, dibutylnaphthalenesulphonic acid or of fatty acids, alkyl- and alkylarylsulfonates, alkylsulphates, lauryl ether sulphates and fatty alcohol sulphates, and salts of sulphated hexa-, hepta- and octa-decanols, and of fatty alcohol glycol ethers, condensates of sulfonated naphthalene and its derivatives with formaldehyde, condensates of naphthalene or of the naphthalenesulphonic acids with phenol and formaldehyde, polycarboxylates or phosphate esters of alkoxylated alcohols.

Suitable nonionic surfactants are polyoxyethylene octyl phenol ethers, alkoxylated alcohols such as ethoxylated isooctyl-, octyl- or nonyl-phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, alkyl polyglycosides, polyoxyethylene alkyl ethers or polyoxypropylene alkyl ethers, lauryl alcohol polyglycol ether acetate, sorbitol esters, lignin-sulfite waste liquors and also proteins, denatured proteins, hydrophobically modified starches, polyvinyl alcohols (for example Mowiol®), polyalkoxylates, polyvinylamines, polyethyleneimines, polyvinylpyrrolidones and their copolymers or block polymers.

Organic liquids (oils) can be employed as components of formulations as solvents or adjuvants. They can also be added to a spray tank dilution as an adjuvant to perform a variety of functions such as, but not exclusively, uptake improvement, spreading, rainfastness enhancement, drift reduction, volatility reduction.

Suitable oils can be oils of vegetable, mineral and animal origin and alkyl esters of these oils such as vegetable oils and vegetable oil esters and diesters (including esters with glycerine and propylene glycol). Some preferred oils are methyl, ethyl, isopropyl, isobutyl, butyl, hexyl and ethyl hexyl esters.

Others are the vegetable oils and esters selected from the group consisting of methyl oleate, ethyl oleate, methyl palmitate, rape seed oil methyl ester, isopropyl myristate, isopropyl palmitate, ethylhexyl palmitate, ethylhexyl oleate, mixtures of ethylhexyl myristate/laurate, ethylhexyl laurate, mixtures of ethylhexyl caprylate/caprate, diisopropyl adipate, coconut oil propylene glycol diester, sunflower oil, rapeseed oil, corn oil, soybean oil and its alkyl esters, rice bran oil and its alkyl esters, olive oil, peanut oil mixed caprylic and capnc triglycerides, and mixed decanoyl and octanoyl glycerides. Also suitable are the mineral oils such as Exxsol D100, Solvesso 200ND, and white oil and the alkyl esters of phosphoric and phosphonic acids such as tris-alkyl-phosphate esters. preferably tris (2-ethylhexyl) phosphate.

Preferably the one or more surfactants and/or oils are selected from non-ionic and ionic surfactants, castor oil ethoxylates, sulphosuccinic esters, alkyl polyglycosides, polypropylene glycol-polyethylene glycol copolymers and/or ethoxylated trisiloxanes.

In a third aspect of the invention there is provided the use of a polymer to reduce the shatter of an agrochemical composition, preferably a herbicide composition, wherein the polymer is selected from one or more polysaccharides, such as one or more of diutan gum, native and modified guar gums, xanthan gum, natural and/or modified cellulosic.

Preferably the shatter is reduced by at least 50%, such as at least 60%, 70%, 75%, preferably at least 85% or even at least 90%.

Unless otherwise stated, quantities of components in percentages are given as percentages by total weight and all embodiments and preferred features may be combined in any combination.

The invention is defined by the following non-limiting Examples.

### EXAMPLES

### Equipment:

Jetting nozzle: Using a Burkert 6712 Whisper Valve, 0.4 mm orifice, EPDM Seal. Burkert Manifold (694895). ¼″ 21G Needle Tip.
Flat Fan: Pulsajet AAB10000AUH-03. Lechler 652.301 (PVDF)

TABLE 1
Agrochemical

| | |
|---|---|
| Katoun Gold | A 50% w/v emulsifiable concentrate formulation containing the |
| | active ingredient pelargonic acid, supplied by Belchim Crop |
| | Protection. |
| Quadris | A 25% w/v suspension concentrate of azoxystrobin, supplied by |
| | Syngenta |
| Touchdown Quattro (TDQ) | 36% w/v soluble liquid containing glyphosate, supplied by Syngenta |
| H-1 | Ionic, water-soluble non-commercial herbicide |

Polysaccharide

| | |
|---|---|
| KELCO-VIS DG | Diutan Gum: High molecular weight polysaccharide consisting of |
| | repeat units of β-1,3-D-glucopyranosyl, β-1,4-D- |
| | glucuronopyranosyl, β-1,4-D-glucopyranosyl, and α-1,4-L- |
| | rhamnopyranosyl, and a twosaccharide L-rhamnopyranosyl side- |
| | chain attached to the (1 → 4) linked glucopyranosyl residue, |
| | supplied by CP Kelco |
| Rhodopol 23 | Xanthan Gum. Linear β-1,4-D-glucopyranose backbone with |
| | alternating O-3-linked trisaccharide side chains of β-D- |
| | mannopyranosyl, β-1,4-D- glucuronopyranosyl, α-1,2-D- |
| | mannopyranosyl with various amounts of acetyl and pyruvate |
| | substituents, supplied by Solvay |
| Akucell AF 3285 | carboxymethyl cellulose ether. Linear chain of β-1,4-D- |
| | glucopyranose units, substituted with carboxymethyl ether groups |
| | on O-6, supplied by Nouryon |
| Jaguar S | native guar gum. β-1,4-D-mannopyranose backbone with α-1,6-D- |
| | galactopyranose residues as single unit side chains, supplied by |
| | Solvay |
| Surfactant | |
| Empicol ESC 70 | water-soluble, anionic alkyl ether sulphate surfactant supplied by |
| | Innospec |
| Aerosol OT-B | anionic surfactant, sodium dioctyl sulfosuccinate containing |
| | sodium benzoate, supplied by Solvay |
| Emulsogen EL360 | non-ionic surfactant, condensation product of castor oil and |
| | ethylene oxide, supplied by Clariant |
| Pluronic PE6400 | non-ionic surfactant, poly(ethylene glycol)-poly(propylene glycol)- |
| | poly(ethylene glycol), supplied by BASF |
| Silwet L-77 | non-ionic, organosilicone surfactant, supplied by Momentive |

Other

| | |
|---|---|
| Sulfacid Blue 5J | water-soluble blue dye used to aid droplet visualisation |
| AMS | ammonium sulphate |

### Methodology

### Formulation Preparation:

All polysaccharides were prepared as a 1% gel in deionized water via high shear mixing prior to use.

Spray solutions were prepared by mixing fully the required quantities of components as defined in the Tables below. In all cases the balance to 100% by weight is water as the carrier fluid.

Sulfacid Blue 5J was introduced to the spray solution at a final concentration of 0.5% w/w.

### Spray Assessments

To assess the effectiveness of polysaccharides in reducing the shatter of compositions, a bespoke spray assessment method was developed. A custom-built static spray rig was built and is equipped with a jetting nozzle operating at 3.0±0.1 bar. Placed 10 cm below the nozzle tip is the target surface, unless specified otherwise, is a circular synthetic fabric substrate (D=20 mm) on a cylindrical support (20 mm×80 mm). This surface has a contact angle of 133±2° with deionised water and is used to replicate difficult-to-wet foliage.

Formulations were loaded into the spray rig and the operating parameters were adjusted to ensure a 14±1 mg dose of spray solution was applied to the target. Located below the supported target surface is a sheet of A4 paper used to capture non-retained spray, with visualisation aided by the blue dye. A total of 10 spray events (e.g., 10 repeats on 10 sheets of paper) were collected for each spray scenario.

Compositions 1 to 27 sprayed with a jetting nozzle and compositions 28 to 30 were sprayed with the flat fan nozzle.

Shatter performance was assessed in following manner. The 10 A4 capture sheets were digitalised using a Brother DS-720D scanner operating at 600 dpi. Subsequently, the digitalised data was analysed using a bespoke ImageJ macro to collate information on droplet number, coordination, and area. Performance was assessed by analysis of the total droplet number, where the shatter reduction is characterised by a percentage reduction in total droplet number.

The results are set out in Tables 2 to 7.

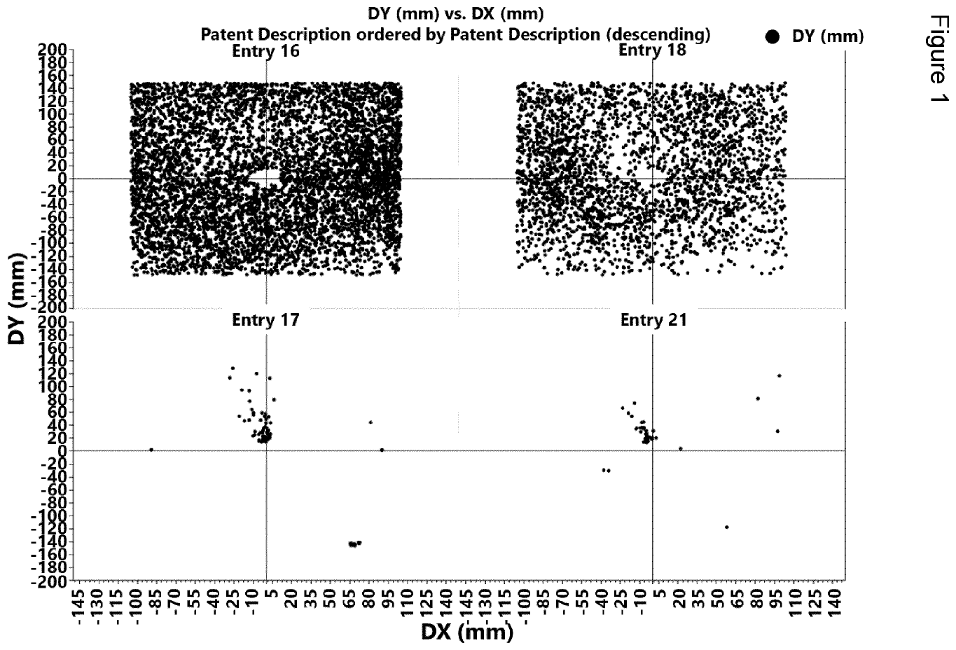

FIG. 1 provides the digitalised droplet location data for formulations entries 16, 17, 18 and 21 and demonstrates the significant improvement in performance for compositions according to the invention.

Table 2. Data Summary for Diutan Gum with Spray Solution containing H-1, at a fixed a concentration of 0.38%. Spray solution also contained 0.25% w/w ammonium sulphate. Empicol ESC 70 is fixed at 0.25%. Nozzle type=jetting nozzle

TABLE 2

| | | | | | | % |
|---|---|---|---|---|---|---|
| | | | | | | Reduction |
| | | Polymer | | | Total | in Total |
| | | Concentration | Active | | Droplet | Droplet |
| Entry | Polymer | (% w/w) | Ingredient | Surfactant | Number | Number |
| 1 | None | 0.000 | None | None | 5068 | — |
| 2 | None | 0.000 | H-1 | Empicol ESC 70 | 10490 | — |
| 3 | Rhodopol 23 | 0.100 | H-1 | Empicol ESC 70 | 8530 | 18.70% |
| 4 | KELCO-VIS DG | 0.025 | H-1 | Empicol ESC 70 | 1497 | 85.70% |
| 5 | KELCO-VIS DG | 0.050 | H-1 | Empicol ESC 70 | 1208 | 88.50% |
| 6 | KELCO-VIS DG | 0.075 | H-1 | Empicol ESC 70 | 116 | 98.90% |
| 7 | KELCO-VIS DG | 0.100 | H-1 | Empicol ESC 70 | 5 | >99.99% |

Table 3. Data Summary for Diutan Gum with various surfactant chemistries. Diutan Gum loading is fixed at 0.10% w/w and surfactant loading is fixed at 0.25% w/w. Nozzle type=jetting nozzle

TABLE 3

| | | | | % Reduction |
|---|---|---|---|---|
| | | | Total | in Total |
| | | | Droplet | Droplet |
| Entry | Polymer | Surfactant | Number | Number |
| 8 | None | Aerosol OT-B | 17917 | — |
| 9 | KELCO-VIS DG | Aerosol OT-B | 1269 | 92.90% |
| 10 | None | Emulsogen EL360 | 9355 | — |
| 11 | KELCO-VIS DG | Emulsogen EL360 | 36 | 99.60% |
| 12 | None | Pluronic PE6400 | 7308 | — |
| 13 | KELCO-VIS DG | Pluronic PE6400 | 109 | 98.50% |
| 14 | None | Silwet L-77 | 11789 | — |
| 15 | KELCO-VIS DG | Silwet L-77 | 30 | 99.70% |

Table 4. Data Summary for solo and mixture polysaccharides with Touchdown Quattro (TDQ). The total polysaccharide concentration is fixed at total 0.10% w/w, with a 1:1 mass ratio for the binary mixtures. TDQ is fixed at 0.72% w/w. Nozzle type=jetting nozzle

TABLE 4

| | | | | % Reduction |
|---|---|---|---|---|
| | | | Total | in Total |
| | | Active | Droplet | Droplet |
| Entry | Polymer | Ingredient | Number | Number |
| 16 | None | TDQ | 6311 | — |
| 17 | KELCO-VIS DG | TDQ | 75 | 98.80% |
| 18 | Rhodopol 23 | TDQ | 2990 | 52.60% |
| 19 | KELCO-VIS DG + | TDQ | 110 | 98.30% |
| | Rhodopol 23 | | | |
| 20 | KELCO-VIS DG + | TDQ | 26 | 99.60% |
| | Akucell AF 3285 | | | |
| 21 | KELCO-VIS DG + | TDQ | 43 | 99.30% |
| | Jaguar S | | | |

Table 5. Data Summary for Diutan Gum spray solutions used with an EC formulation (Katoun Gold, Al=Pelargonic acid). Polysaccharide concentration is fixed at 0.10% w/w, Pelargonic Acid is fixed at 10% w/w. Nozzle type=jetting nozzle

TABLE 5

| | | | | % Reduction |
|---|---|---|---|---|
| | | | Total | in Total |
| | | | Droplet | Droplet |
| Entry | Polymer | Active Ingredient | Number | Number |
| 22 | None | Pelargonic Acid | 11901 | — |
| 23 | KELCO-VIS DG | Pelargonic Acid | 76 | 99.40% |
| 24 | Rhodopol 23 | Pelargonic Acid | 68 | 99.40% |

Table 6. Data Summary for Diutan Gum spray solutions used with SC (Quadris, Al=azoxystrobin) formulations. Polysaccharide concentration is fixed at 0.10% w/w. Quadris is fixed at 0.83% w/w. Nozzle type=jetting nozzle

TABLE 6

| | | | Total | % Reduction in |
|---|---|---|---|---|
| | | Active | Droplet | Total Droplet |
| Entry | Polymer | Ingredient | Number | Number |
| 25 | None | Quadris | 5173 | — |
| 26 | KELCO-VIS DG | Quadris | 16 | 99.7 |
| 27 | Rhodopol 23 | Quadris | 1251 | 75.8 |

Table 7. Data Summary for Diutan Gum spray solutions used with Touchdown Quattro. Here the polysaccharide concentration is fixed at 0.10% w/w and Touchdown Quattro is fixed at 0.72% w/w. Nozzle type=flat fan. In this instance the target substrate was an oval (D=40×80 mm) placed on an elliptical cylindrical support (40×80 mm×80 mm).

TABLE 7

| | | | | % Reduction |
|---|---|---|---|---|
| | | | Total | in Total |
| | | Active | Droplet | Droplet |
| Entry | Polymer | Ingredient | Number | Number |
| 28 | None | TDQ | 39815 | — |
| 29 | KELCO-VIS DG | TDQ | 13624 | 65.80% |
| 30 | Rhodopol 23 | TDQ | 43384 | −9.00% |

It can be seen that t e compositions according to the invention demonstrate a remarkable improvement in the reduction of shatter.

The invention is defined by the claims.

1. A composition comprising:
a. an agrochemical;
b. diutan gum; and
c. a carrier fluid,
wherein the diutan gum is present in an amount of from 0.001 to 2% by weight,
wherein the carrier fluid comprises water and is present in an amount of from 65 to 95% by weight.

2. A composition according to claim 1, wherein the agrochemical is present in an amount of from 0.0001 to 25% by weight.

3. A composition according to claim 1, wherein the diutan gum is present in an amount of from 0.01 to 0.20% by weight.

4. A composition according to claim 1 comprising one or more surfactants and/or oils.

5. A composition according to claim 4, wherein the non-ionic and ionic surfactants, preferably castor oil ethoxylates, sulphosuccinic esters, alkyl polyglycosides, polypropylene glycol-polyethylene glycol copolymers and/or ethoxylated trisiloxanes.

6. A composition according to claim 1 comprising an additional polymer, wherein the polymer is selected a polysaccharide.

7. A composition according to claim 6 wherein the additional polymer is selected from one or more of native and modified guar gums, xanthan gum, natural and/or modified cellulosic

8. A composition according to claim 1 suitable for use in a precision application device.

9. Use of a composition according to claim 1 in a precision application device.

10. An precision application device and a composition comprising:
a. an agrochemical;
b. a polymer; and
c. a carrier fluid;
wherein the polymer is selected from one or more polysaccharides.

11. A device according to claim 10 comprising a nozzle, preferably a jetting nozzle or small angle flat fan nozzle

12. A device according to claim 10, which dosing deposits at an application rate of 20-3000 L/Ha, preferably 200-500 L/Ha.

13. A device according to claim 1, wherein the polymer is selected from diutan gum, native and modified guar gums, xanthan gum, natural and/or modified cellulosic

14. A device according to claim 1, wherein the carrier fluid comprises water.

15. Use of a polymer to reduce the shatter of an agrochemical composition, wherein the polymer is selected from one or more polysaccharides.

16. Use according to claim 15, wherein the shatter is reduced by at least 50%, preferably at least 85%.

17. Use according to claim 1, wherein the agrochemical composition is a herbicide composition.
